(19) United States
(12) Patent Application Publication
(10) Pub. No.: US 2003/0004746 A1
(43) Pub. Date: Jan. 2, 2003

(54) Scenario based creation and device agnostic deployment of discrete and networked business services using process-centric assembly and visual configuration of web service components

(76) Inventors: Ali Kheirolomoom, Danville, CA (US); Tim Buss, Novato, CA (US); Alex Tsibulya, Daly City, CA (US); Thomas Clement, Berkeley, CA (US); Christopher Foskett, San Francisco, CA (US)

Correspondence Address: Paul Davis; Heller Ehrman White & McAuliffe, 275 Middlefield Road, Menlo Park, CA, 94025, US

(21) Appl. No.: 10/133,964

(22) Filed: Apr. 24, 2002

Related U.S. Application Data
(60) Provisional application No. 60/286,230, filed on Apr. 24, 2001.

(51) Int. Cl. G06F 17/60

(52) U.S. Cl. 705/1

(57) ABSTRACT

The invention provides a process-centric, scenario-driven business service assembly software environment that uses encapsulated, iconographic building blocks—each representing a discrete Web Service component to be executed within a business service—to logically depict service processes as well as complex relationships between these processes, their audiences, and means of deployment. Fundamental to the invention are an Interactive Flow Assembler, an Interactive Flow Engine, a design-time Service Manager, and an implicit XML-based data and process model. Business users employ the Interactive Flow Assembler to create online business services that are executed by the Interactive Flow Engine by chaining a series of logical business steps that codify business rules, collect data, and take actions. The Services Manager leverages Web Service standards to provide collaborating business analysts and IT resources with an environment in which to centralize business-relevant decisions such as business rules, authorized data sources, design-time and runtime roles and profiles, and deployment characteristics to change the appearance and behavior of applications built using the Interactive Flow Assembler. The invention's intrinsic data and process model facilitate easy integration of networked business services built using the invention as well as the underlying datasets captured by the online business services.

### CROSS-REFERENCE TO RELATED APPLICATIONS

This application is a continuation of and claims the benefit of U.S. Ser. No. 60/286,230 filed Apr. 24, 2001, which application is fully incorporated by reference herein.

### BACKGROUND OF THE INVENTION

The World Wide Web has created the opportunity for companies to create and distribute applications that render and collect information interactively with customers and other key constituents in order to engage those audiences and deliver valued business services online. Unfortunately, the cost of creating these online applications in both time and money has limited the ability of businesses to offer, modify and re-deploy Web applications in response to continuously changing market conditions.

Many Web applications manifest the user or market-facing aspects of a business' internal and external processes. These processes may represent a significant value to a business, but they are typically proprietary and hence re-implemented across similar businesses. While data sharing and syndication has become more common on the Web the difficulty of syndicating business processes has effectively prevented this potentially lucrative and efficient business model from being widely adopted.

Web-based interactive applications between a business and its customers typically occur within a single session at the computer. However, many business processes have multiple stages that may comprise a number of smaller interactions and potentially involve multiple parties inside or outside corporate boundaries at different points in time. For example, a process might be initiated by an interaction with a customer who posts a request for a product or service. After reviewing the request internally, the process might require a separate interaction with a distinct business unit or division to fulfill the previous request or otherwise obtain a needed component or service. Current Web applications cannot effectively model and expose networked business services because of the complexity of designing and implementing this type of staged, multiple-party interaction processes resulting in a monolithic application that is difficult to maintain and customize. The method and system of the present invention leverages the emerging XML Web Services technology to create a service-based architecture that allows enterprises to assemble modular business services that perform discrete functions and are targeted at specific audiences inside or outside of the enterprise. These business services can then be dynamically linked together to form networked business services that manages the lifecycle of service request and delivery processes spanning departmental and company boundaries.

### SUMMARY OF THE INVENTION

The invention is a scenario-based design, deployment, and management environment that uses state-of-the-art in Internet and Web services technologies to allow businesses to automate the processes associated with delivering valued business services online and fully exploit the benefits and efficiencies offered by successful online strategies. The invention enables rapid, visual assembly of dynamic, scalable, scenario-driven interactions called NetScenarios. By dramatically simplifying application building and service delivery processes, the invention transforms online service assembly and deployment from a technological hurdle to a business imperative. The invention abstracts technical implementation details to create an environment where business experts are empowered to create, deliver and manage their own online solutions.

The invention exploits the introduction of open Internet and XML Web Service technologies such as XML, UDDI, WSDL and SOAP to leverage the strength of the Web, distributed networks, and intelligent access devices for creating and reusing company and external assets. By using modular Web services as building block components, the invention provides a natural and structured environment for rapid and effective collaboration between business experts and application developers, programmers and other information technology (IT) professionals.

The invention enables the combination of individual NetScenarios into larger multi-stage, multi-party networked business services that automate interactive processes spanning departmental and company boundaries.

The invention enables the syndication of complete interactive business processes to value chain partners and distributors to create new online marketing channels and promote new business opportunities for the enterprise.

### BRIEF DESCRIPTION OF THE DRAWINGS

FIG. 1 is an illustration of Scenario Map Flow Assembly of the present invention.

FIG. 2 depicts the Dynamic Directed Graphing Algorithm of the present invention.

FIG. 3 depicts the Automated Branch Definition Based Upon User Selectable Options of the present invention.

FIG. 4 depicts the Dynamic Mapping and Binding of Step Inputs and Outputs of the present invention.

FIG. 5 depicts the Selection of Web Service Steps Publish by IT for Business Use of the present invention.

FIG. 6 depicts the Dynamic Discovery of Web Service Components from UDDI of the present invention.

FIG. 7 depicts the Business-to-IT Collaboration with Integration with Native Development Environments of the present invention.

FIG. 8 depicts the Business Definition of Web Service Functional Requirements with Inputs and Outputs of the present invention.

FIG. 9 depicts the Defining Step Placeholder

Status to Alert IT to New Web Service Request of the present invention.

FIG. 10 depicts the Service Manager to Abstract Technical Details from Business Users of the present invention.

FIG. 11 depicts the Example of Deployment-Time Provisioning to Alter Runtime Behavior of the present invention.

FIG. 12 depicts the Flow Segment Modeling and Control of User Navigation of the present invention.

FIG. 13 depicts the Scenario Nesting Through Redirector Platform Service of the present invention.

FIG. 14 depicts the Scenario Nesting Through Redirector Platform Service of the present invention.

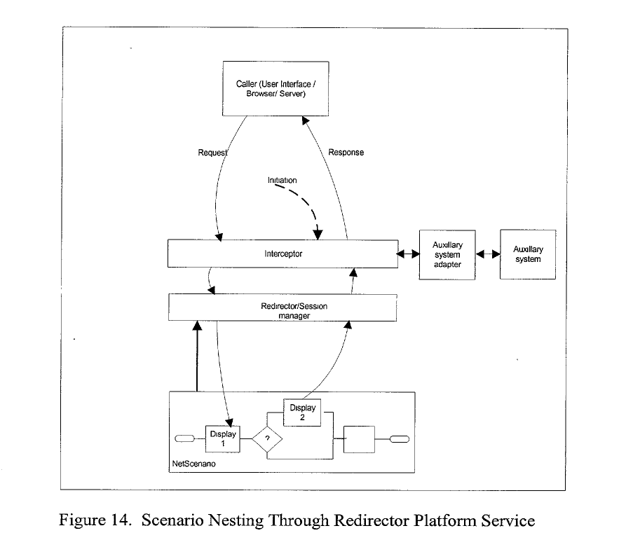

FIG. 15 depicts the Gather-Submit Service Design Pattern of the present invention.

FIG. 16 depicts the Gather-Submit Transaction Model of the present invention.

FIG. 17 depicts the Merged Gather-Submit Operation of the present invention.

FIG. 18 depicts the NetScenario Logical Model of the present invention.

FIG. 19 depicts the NetScenario Physical Model of the present invention.

FIG. 20 depicts the NetScenario Operational Model of the present invention.

FIG. 21 depicts the NetScenario Compiler Operation of the present invention.

FIG. 22 depicts the NetScenario Compiler Output Generation of the present invention.

### DESCRIPTION OF THE INVENTION

The method and system present invention provides a robust business service assembly, configuration, deployment and management environment that leverages Web services to allow organizations to conceive, create, and deploy new scenario-driven services across a variety of online channels and smart access devices more quickly and with greater flexibility than previously possible with traditional development tools. The software of the present invention consists of two separate components, called NetScenario Studio and NetScenario Business Server.

Overview of the Method and Apparatus of the Present Invention

NetScenario Studio is an integrated environment for the design, testing, staging and deployment of the Web-based processes associated with delivering business services to customers, partners and other constituents of the enterprise.

The following section describes the major concepts in NetScenario Studio, including:

1. Roles and Phases

2. Business Service Assembly

3. Staging and Deployment

Roles and Phases

Use of the NetScenario Studio can be broken down into a number of distinct phases, including planning, assembly, staging, deployment and management. The initial phase is NetScenario planning, whereby the overall business objectives and focus of the scenario-based service is defined. This is followed by the assembly phase that includes distinct NetScenario design, configuration and formatting activities that combine to create the end NetScenario business service. After the assembly phase is complete, NetScenarios are staged and deployed for production use. At runtime, after it has been deployed, users interact with the enterprise and experience the business service by executing the delivered NetScenario. Finally, interested and authorized business managers can view utilization reports and otherwise monitor the results of NetScenarios that have been experienced through the various channels and devices. Throughout these phases the NetScenario Studio environment provides support for administrative tasks like controlling user rights and access privileges.

Users of the product fall into the following categories:

| Role | | |
|---|---|---|
| Name | Responsibilities | Scope |
| Business | Analyzes business needs and defines | Involved in |
| Analysts | logical application model to accomplish | planning, |
| | the needs. Works with developers to | assembly, |
| | define and refine requirements for steps | staging, |
| | extending an existing set of available | deployment, and |
| | services, | management |
| | | phases. |
| Web | Designs look and feel of Web pages. | Involved |
| Designers | Addresses branding and related issues in | primarily |
| | provisioned and non-provisioned | in the assembly |
| | NetScenarios, | and deployment |
| | | phases. |
| De- | Works with Business Analysts to define | Involved in the |
| velopers/ | and refine requirements for steps extend- | assembly, |
| IT | ing the existing set of available services, | staging and |
| | Implements or discovers Web services | deployment |
| | meeting agreed upon requirements. | phases. |
| Customers | Interacts with published NetScenarios to | Involved at the |
| | obtain information and/or enter data for | runtime stage |
| | processing. | only. |
| Business | Views data collected from customers after | Involved in the |
| Users | the interactions have been completed. | management |
| | Provisions subscribed NetScenarios, | phase after |
| | | the runtime |
| | | interaction |
| | | with the |
| | | customer has |
| | | been completed. |
| Adminis- | Determines rights and privileges of | Involved in all |
| trators | Business Analysts, Developers, IT | phases of product |
| | personnel Customers and Business users. | use and operation. |
| | Responsible for physical deployments and | |
| | component configuration. | |

Business Service Assembly

The methods and systems of the present invention provide the business service assembly environment that permits business analysts to design and implement modular scenarios by combining “steps” corresponding to interactive user presentation pages with steps that implement business decisions and interaction logic. These scenarios can then be dynamically delivered to a variety of channels including corporate Web sites, enterprise portals, rich email messages, UDDI, and intelligent access devices such as mobile phones and personal digital assistants (PDAs). For example, one embodiment of the methods and systems of the present invention for obtaining price quotes can be implemented as the following sequence of steps:

1. An Interaction step (e.g. a Web page) asking the customer for a description of the item.

2. A step that calls a Web service to look up possible corresponding merchandise using a full text search engine.

3. An Interaction step that presents the results of the search along with associated price quotes.

There are several sources of the steps used to build the methods and systems of the present inventions. First, a Business Step Library is included as a standard part of the product. Second, if the enterprise has developed custom steps, it can add them to the Step Library for general use. Finally, when the business user needs a step that does not currently exist, he or she can either dynamically create a step by discovering Web services from public or private UDDI registries or request a Web service implementation from IT. The IT request may be fulfilled using either an internally developed service or an external Web service.

By abstracting low-level programming details from the primary audience of business analysts, the methods and systems of the present invention uniquely empowers the business analyst to define fully functional multi-service, device-independent interactions without significant dependencies on developers, programmers and other IT resources.

Service Assembly Environment

In one embodiment, methods and systems of the present invention provide a library of building blocks called Business Steps together with a Scenario Map representing the logical view of the business service process to be designed and assembled using the environment. The steps are dropped onto the Scenario Map and visually connected to depict the interaction flow and the associated user experience. Steps that support conditional branching enable the designer to apply business rules to control the path taken by users upon invoking the business service. The Scenario Map is a directed flow graph that upon compilation will execute a dynamic computer application whose runtime behavior is driven by the logic represented by the map.

Graphical representations of electronic processes are typically assembled by placing unconnected process components on a drawing surface, then manually connecting to form the process them by drawing links connecting the components. The invention introduces a new method that simplifies the creation of the Scenario Map, a graphical representations of an electronic process.

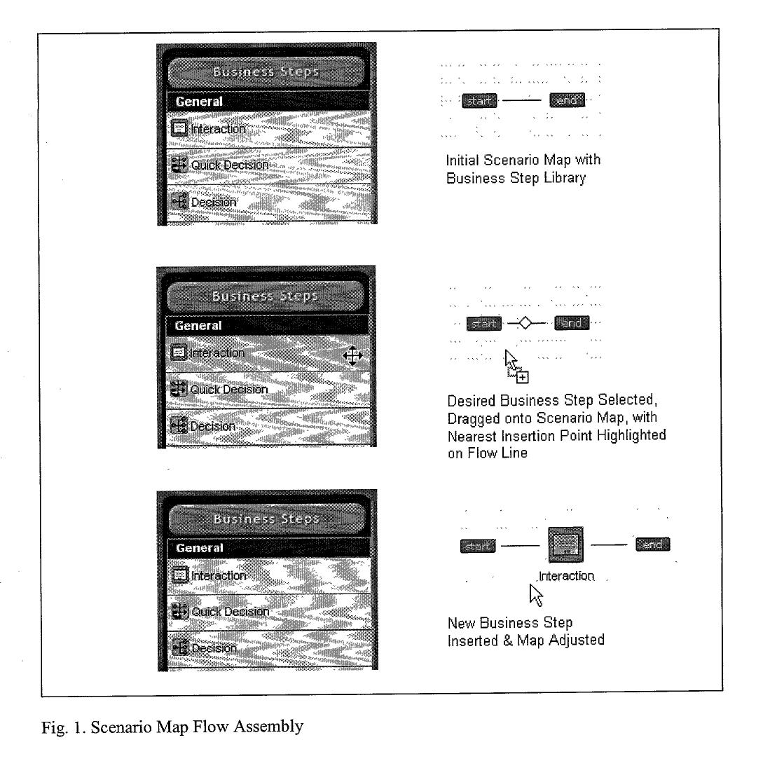

With reference to FIG. 1, Scenario Maps contain linked Start and End steps when first created. Additional steps are included on the map by selecting them from the Business Step Library and dropping them onto an existing link between steps. The methods and systems of the present invention auto-generate connections between new and existing steps based upon the insert point of the new step. The methods and systems of the present invention expedite the process of connecting business steps. In one embodiment, the methods and systems of the present invention automatically place the business step as soon as the step is dropped onto an existing flow line and automatically establishes connection lines to steps before and after it thus eliminating the need to delete links, add new steps in the right location and reestablishing links.

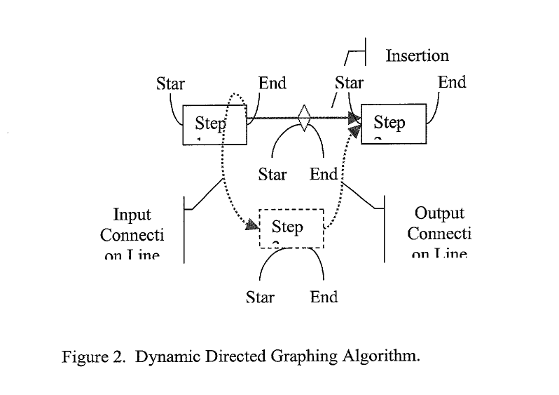

Referring now to FIG. 2, the following sequence can be followed to connect business steps for the purpose of connecting input and output.

1. Select Step 3 from the Step Library through a left mouse click and drag it over the line where it must be placed.

2. The mouse-over action detects valid drop points and places an insertion point symbol visually notifying the designer that it is a valid drop point.

3. The de signer un-clicks the left mouse and the selected step is visually placed between steps 1 and 2. The input and output connection lines for Step 3 are automatically drawn replacing the previous connection line between Steps 1 and 2.

4. All subsequent steps to the right of the insertion point are automatically moved to new coordinates to accommodate the newly added step.

In the FIG. 2 embodiment, each step has “Last Node ID” and “Next Node ID” designators. When Step 3 is dropped at the insertion point, Step 1.NextNodeID is linked to Step3; Step3.LastNodeID is linked to Step 1; Step3.NextNodeID is linked to Step2; Step2.LastNodeID is linked to Step3 The coordinates of all subsequent steps on the map are recalculated to accommodate Step 3 in line between Steps 1 and 2. The lines are redrawn to accommodate the steps' new coordinates.

With the methods and systems of the present invention, the designer can seamlessly move an existing step from one flow line to another by dropping it on top the desired location. To accommodate branching in the interaction flow for the purpose of conditional evaluations (or business rules), the approach is to define the various potential outcomes of the rule regardless of the actual rule such that a flow line for that outcome can be created. A similar technique is used to accommodate looping. This technique automatically creates a correct structure for the underlying application program.

As Business Steps are added to the Scenario Map, the invention further guides the graphical business service definition by automatically validating intended placement locations to ensure that only structurally and logically correct connections are permitted by users. This prevents productivity loss and ensures more rapid creation of valid service processes that fulfill their intended business purpose.

After the user makes a change to the scenario map—such as moving a step, deleting a step, adding a step, or configuring a step—the invention validates that all business logic contained inside the step is valid. Invalid conditions include missing values, invalid values (a string in a number field, for example), or referencing other steps that will not have been executed. The system performs just-in-time validation by performing a type check comparing the data type of the entered values against the data types associated with configuration fields within each step. Incompatible types are visually flagged by dynamically placing an error icon on the affected step.

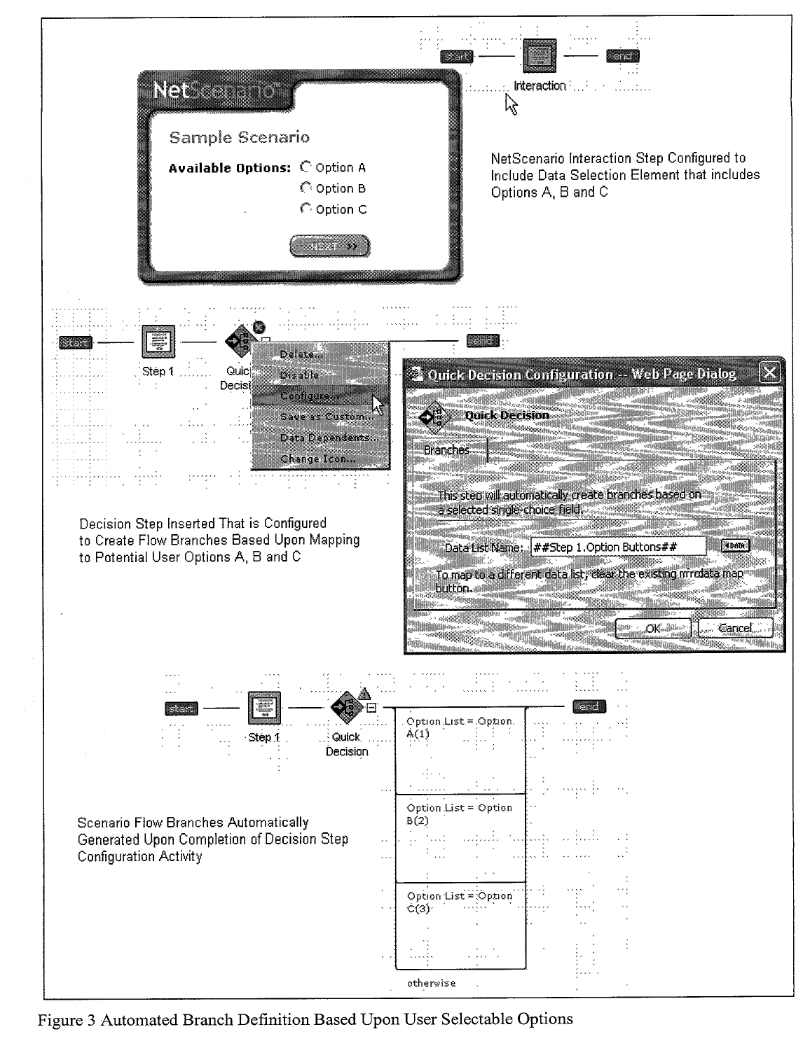

Interaction logic, flow branches and business rules are defined within Scenario Maps through placement of Decision Steps. With reference to FIG. 3, when a Decision Step is placed on the map and configured to correspond to a fixed list of user selectable options, the invention automatically extends the Scenario Map to include labeled exit branches for each available option that converge at the input of the step that immediately follows the Decision Step at the time it is placed on the map. Steps executed only when a branch is executed are added to the branch from the step library or moved from other parts of the map by dragging and dropping. This further accelerates graphic service modeling by avoiding the need to define these branches and their associated business rules explicitly.

After the user changes a List's values, any step on the map that uses those values is updated to reflect the change. For example, assume options “a”, “b”, or “c” were contained in a list and referenced by a decision step. If the list is updated to include “d”, the decision step will then automatically acquire an additional branch labeled “d”. If “d” is then removed, the branch will also be removed. If the branch contains additional steps, the system would then automatically disable these steps and label them as inactive allowing the user to safely move these steps to another location in the scenario map.

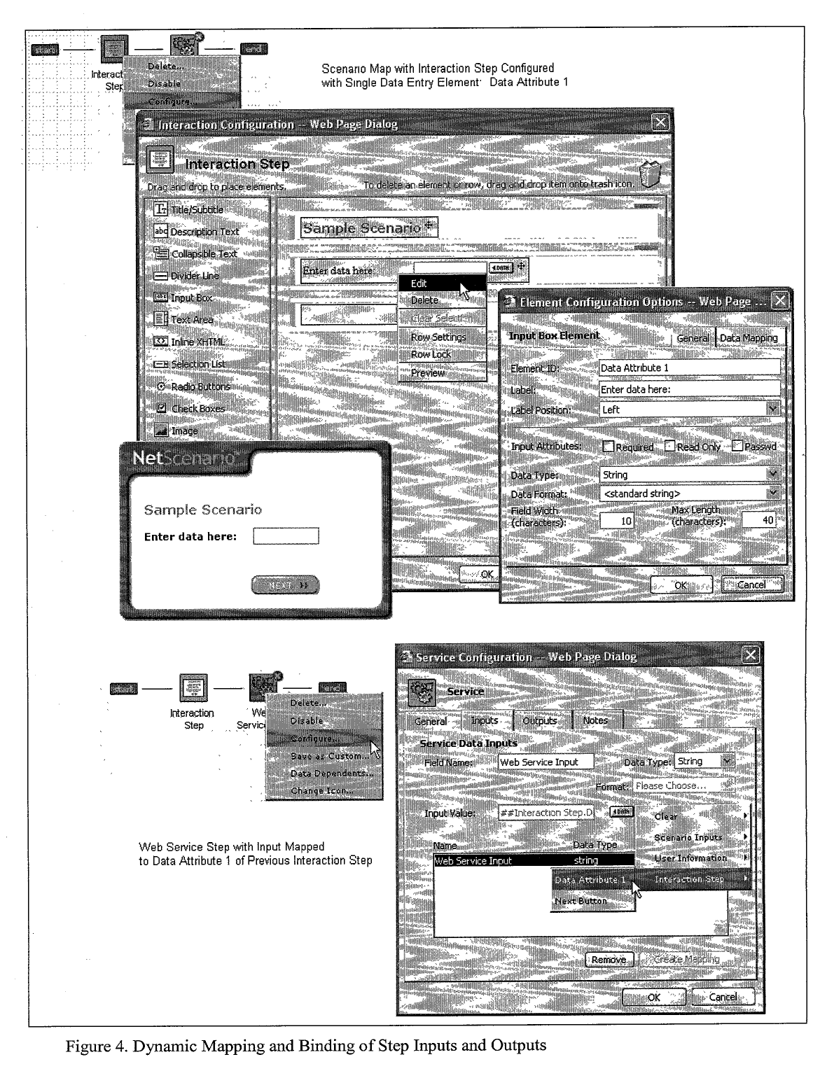

Business service processes and user experiences are described as a directed flow graph through the sequential placement of Business Steps on the Scenario Map. Individual steps in the Step Library are represented as iconographic elements. After the user drags and drops the step in place, they configure the step by double-clicking on the icon to launch a dialog box for setting any configurable behavior of that step. With reference to FIG. 4, interface element values and outputs from previous steps are dynamically detected and made available for use during the configuration of any step. The auto-mapping feature of the invention automatically suggests a default mapping of the appropriate inputs and outputs amongst various business steps. Once input and output parameters have been properly mapped between steps, the invention automates the final binding of the steps to create a fully functional service process model for execution at runtime. The Scenario Map created in this manner is stored as an XML document that represents the contract for the business service and fully describes the logical design of the service. Because the Scenario Map is a logical rather than physical representation of both procedural and visual aspects of the service, it can be converted (compiled) into distinct forms that execute the Business Service in various environments. For example, interaction (visual) steps can be compiled into a form that can be rendered by the Server Software of the present invention or alternatively into a form that can be rendered as an ASP.NET web page.

The inputs available to any given step are derived from the outputs of all steps that have executed prior to that step (steps visually appearing to the left of the step). The collection of available steps for data mapping is determined for each step individually by one of several means, including:

a) Find all paths to the step from the start of the process

b) Keep track of all steps and keep a “breadcrumb” of steps that have executed, labeling the step as it is drawn.

In order to facilitate ongoing review and refinement of the intended business service, the invention allows the Business Service to be tested in a Web environment at any point during this design process. On demand, the service process model defined by the Scenario Map and its underlying XML document structure are compiled to create an executable version of the Business Service that is then previewed inline. This permits testing overall usability, interaction logic, branding and any other characteristics of the business service under design. Please refer to the “Technical Details” section for details of the compilation process.

Difficulties arising from user control of the process become more severe when a portion of the NetScenario experienced by the user is a nested NetScenario potentially outside the control of the business publishing the first NetScenario. When one company provides a service that includes a series of one or more Web user interfaces with the intent for another company to use it as a part of a larger Web application, the client company typically wants the pages provided by the service to appear consistent with others that may be part of their application. There are two aspects to this, the general look of the page (colors, fonts etc) and its layout (where interface elements are located on the page). These two aspects require different solutions.

By using an interception model in which the primary NetScenario server maintains the connection with the browser, it can directly manage the user navigation problems.

The first aspect, “look”, is addressed by using a predefined Web page presentation model that can be themed. The page model contains certain elements whose final presentation is left until runtime. Themes containing these definitions are defined externally from the NetScenario. Theme definitions may contain both graphics and text styles. At runtime a particular theme may be chosen which will give a NetScenario a particular look. Themes are parameterized on NetScenarios to the extent that the caller may override some or all the theme. The intent is that the theme instructions can be passed down to nested NetScenarios, or the nested NetScenarios may be instructed to defer all or part of their theme application to the caller. This arrangement allows nested NetScenarios to apply branding information, if so desired, so that the origin of the nested NetScenario is not lost.

The second aspect, “layout”, is addressed by importing that part of the NetScenario definition that describes the presentation into the consuming NetScenario when the consuming NetScenario is being designed. NetScenarios store their UI definitions in a way that can be separated from their underlying logic. By importing the UI the consumer gets full control of both theme and page layout (within the limits allowed by the NetScenario model). The underlying NetScenario is effectively converted into a sequence of Web service calls each of which encapsulates the logic between their respective pages. Thus they dictate which page of the UI should be displayed next and which Web service should be called after that page. The consuming NetScenario is responsible for mapping data from these Web service calls into the appropriate pages and returning data collected from the pages to the appropriate Web service. NetScenario Studio automates this mechanism. This mechanism allows the developer of the consuming NetScenario control over additional graphical embellishment of those pages beyond that typically allowed by the themes.

The two aspects are treated separately since the first, “look,” can be applied with no knowledge of the internal workings of the nested NetScenario. The nested NetScenario can potentially be upgraded without affecting the caller so long as it maintains its calling interface. Maintaining a calling interface is often referred to as a contract. The second, layout, is more intrusive since the nested NetScenario must expose the pages it expects to display. Once the caller has bound to these, they become part of the contract between the caller and the called. This limits the type of upgrades the can be made to the nested NetScenario without requiring the calling NetScenario to be re-built.

Business Step Extensibility

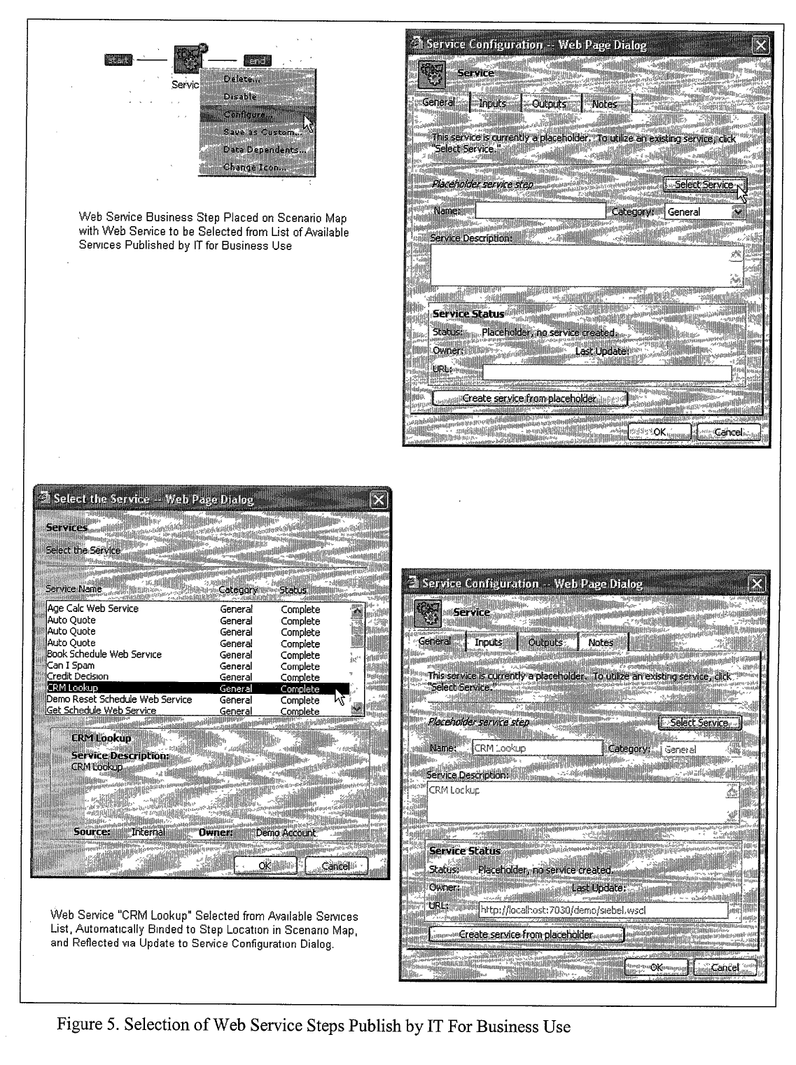

The NetScenario Studio environment includes a comprehensive Business Step Library for building service processes and the interactive functionality they contain. The invention enables near limitless extensibility by allowing business users to visually and without programming discover, select and integrate any WSDL-compliant Web Service component as part of this library. With reference to FIG. 5, these Web Services can include those specifically developed and made available to business users by their IT counterparts (see Section 2C, Business-to-IT Collaboration below), as well as Web Services made available through public or private UDDI registries that provide the required business functionality.

The following steps are used to configure and abstract the web service for use within the NetScenario.

1. From within Service Manager, the IT user creates a new Service and specifies the underlying web service. The web service may be entered in multiple ways including the following:

Manually. IT user enters the URL to the web service.

Via integration with programming environments such as Microsoft Visual Studio NET or Borland JBuilder.

Via discovery from UDDI public or private registries.

2. Once the web service has been selected, the IT user may provide additional configuration for the web service that transforms the web service into a business friendly entity. From the Business User's perspective, they are working with an abstraction of the service thus enabling them to focus on the goal rather than the implementation.

3. The IT can then make the service available to the Business User and the collaboration between Business User and IT user continues. At this point the Business User and the IT Users are engaged in an iterative process which will ultimately result in a service that meets the business requirements.

4. From within the NetScenario, and specifically the Service Step, the Business User may select the service which they collaborated on with the IT user. To ensure the highest level of usability for the Business User, the Service Step provides auto-mapping and synchronization between the originally requested “service placeholder” (an method interface prototype) and the modified service abstraction which resulted from the iterative collaboration process.

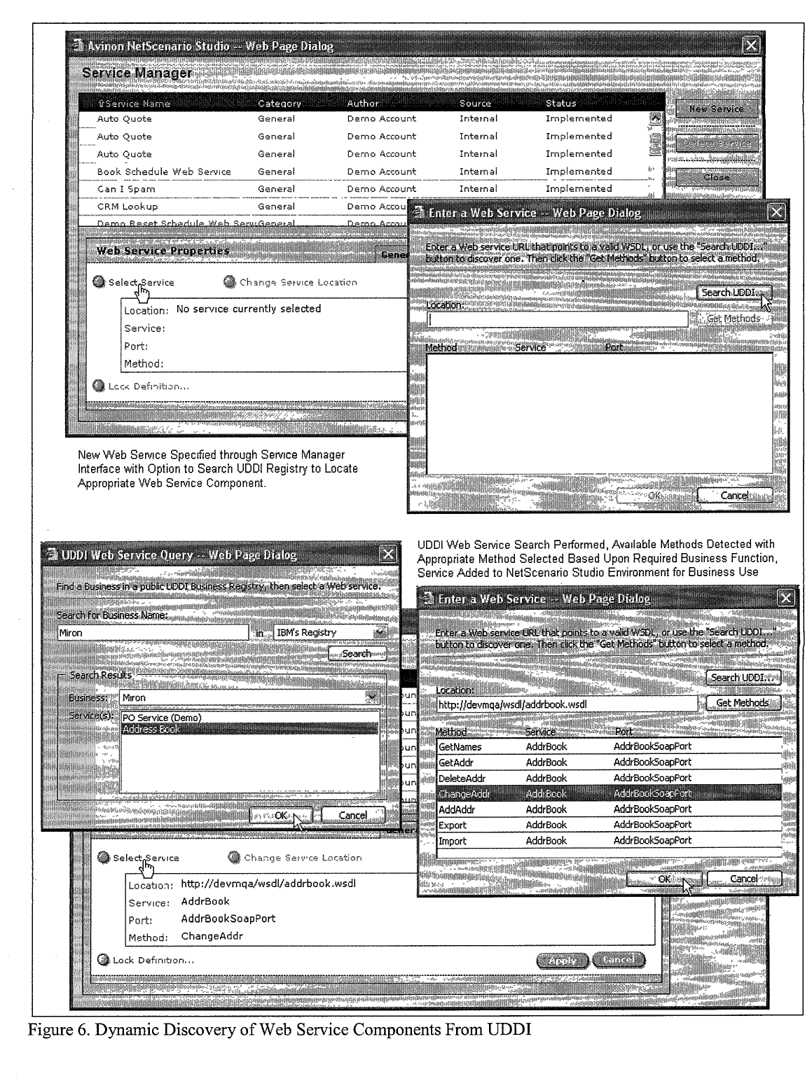

As new Business Step requirements are identified, NetScenario Studio users begin discovering new steps through placement of a special Service Step at the appropriate execution point in the Scenario Map. With reference to FIG. 6 and as described above, the IT user may discover the underlying web service from a UDDI registry. The IT user discovers the web service using the UDDI query tools provided with the platform. The invention further facilitates this by automatically detecting the available Web Service methods and their corresponding business functions, as well as the input and output parameters for each method that will ultimately be mapped to the service process using the procedure described in Section 2a above.

As an extension of the above design-time selection and binding of Web Services, the invention allows for the definition of groupings containing multiple Web Services with functionally equivalent methods and contract schemas. At runtime, one of the constituent Web Services is dynamically selected and bound to the service process based upon business rules and operational criteria such as cost, availability, performance, etc. Alternatively, the runtime binding information may be discovered via a query to a public or private UDDI registry, further supporting the distributed management of Web Services. The parameters for this runtime query may be collected from the user through an interaction step or provided as an output of other action-oriented steps placed on the Scenario Map such as Web services, database lookups, and similar functions. This grouping mechanism is managed within the Service Manager using the following process:

1. The IT user follows the processes described above for selecting and configuring a web service that is then made available to the business user. Once the interface for the web services is agreed upon, the IT user may specify additional web service end points that could process the requests made to the service of the present invention.

2. The IT user enters additional URLs which should represent web services with identical WSDL interfaces.

3. For each URL specified, the Service Manager will validate the compatibility of the URL with the WSDL specified for the originally configured web service. This ensures that the NetScenario will be able to consume the web service at run-time. From the Business User's perspective, they are unaware that multiple web services could be used to process the logical service request. These details are more appropriate as an IT User's responsibility.

As an advanced feature, the IT user may also select an incompatible, yet logically equivalent, web service and then use an additional abstraction mechanism to map the logical definition for the web service to the physical definition for the particular web service which does not have an identically compatible WSDL interface.

The following example demonstrates this point. Let's imagine a Business User has requested the “Validate Credit Card” service which the IT User will implement using web services from partner financial institutions which provide web services in this area.

Note: the URLs and other technical information below (within this sub-claim) is offered as a “pseudo-code” example only and is not intended to be representative of the underlying workings of a particular web service toolkit.

http://financialPartnerA/CreditCardTools/ValidateCreditCard

Method: (string CustomerNumber, string CreditCardNumber, date ExpirationDate)→string ConfirmationID

http://financialPartnerB/CreditCardUtilities/CreditCardValidation

Method: (integer PartnerNumber, string CCNumber, string ExpireDate)→string integer ConfirmationID

In this example, while the two web services accomplish the same logical goal, they have two primary differences in their calling syntax: a) the parameter names are different, and b) the parameter types are different. Using the advanced service abstraction functionality within the Service Manager, the IT user may include these dissimilar web services within the Service Group which process the Business User's “Validate Credit Card” service requests.

The IT User is provided fall control over this mapping enabling maximum flexibility in building a robust Service Group with multiple business partners.

IT personnel may reference and configure technical resources (for example, using a third party Web Service, an internally-developed Web Service, a .NET assembly, a COM object, EJB object or database query exposed through a Web Service) to abstract the complexities of the underlying technologies such as WSDL, SOAP, and XML. A “Business Resource” is created to represent the underlying technical resource in a business friendly and relevant manner. These Business Resources may be assigned additional meta-data or attributes in a manner that allows the Business Analyst to easily find resources which are meaningful to their particular business problem. Valid attributes for the Business Resource are defined within a classification model that may be defined by either the IT personnel or the Business Analysts for maximum flexibility. Additionally, the query interface for these Business Resources may include public or private UDDI registries as the data source for the query. A typical Business User will work with numerous Technical Resources within and across NetScenarios. The two sides of this functionality include: a) Resource classification and b) Resource discovery based on query. A Resource is classified before it is queried. These are accomplished as follows:

Resource Classification:

From within the Business Resource Center, the Business User selects a particular Business Resource. (Note: “Business Resource” is synonymous with references to “services”—but not web services—in this document. Services are generically the term that applies to the entity collaborated on by Business Users and IT Users. Business Resources refer to the Business User's view of the service. Technical Resource refers to the IT User's view of the resource.)

Once the Business User has the Business Resource locked for edit, they may classify the resource using a set of attributes. Examples of these attributes include “category” (e.g. finance, human resources, etc.) and “source” (e.g. originated internally, 3^{rd} party, customer request). The attributes are set for the resource and any Business or IT User who has permissions to access the resource may discover the resource via a query within the Business Resource Center.

Resource Discovery:

From within the Business Resource Center or the Service Step, the Business User will navigate to “Service Discovery” and enter their search criteria. The search criteria entry automatically conforms to the classification system defined for the account. This provides a very friendly and intuitive means of finding the resources since the Business User will be directed to enter search criteria that conforms to a set of valid parameters and values.

Upon invocation of the query, the Business User is presented with the list of resources matching the search criteria. At this point the Business User may refine their search criteria to further narrow (or broaden) the scope of the search, or they may drill into a selected resource for edit/review purposes. Additionally, in the Service Step context, the Business User may select the found resource for use in the NetScenario.

As companies move toward a Services Oriented Architecture, applications become more dependent on Web Services that are distributed outside well-controlled Enterprise boundaries. These dependencies upon external Web Services require rapid adaptation to changes in the availability of external systems. Multiple companies may provide similar (if not exact) Web Services in a particular functional area. For example, there will probably be multiple providers of a credit card authorization Web Services. Each of these credit card validation Web Services may conform to an industry standard contract for such functionality. After registering and configuring a set of Web Services which adhere to the same WSDL contract, IT personnel can group these Web Services into a Virtual Web Service. The IT personnel may then define a set of binding rules that dictate which specific Web Service will be used by the NetScenario at run-time. This brokering behavior enables the NetScenario software to dynamically react to disruptions in resource availability with no intervention from IT personnel. The concept of Service Groups was introduced in a prior section. This sub-claim elaborates on the dynamic identification and selection of web services at run-time. Once the IT User defines a Service Group (a grouping of web services that behave logically the same and usually adhere to a common WSDL interface) the IT User may configure the Service Group with a set of rules. These rules dictate the run-time selection of a particular web service to process the service request. Multiple rules may be associated with a Service Group and these rules may be grouped and prioritized.

In addition to the basic rules that are available within the Service Group Manager, the Service Group rules architecture is extensible and allows the installation of new rules without requiring a new product version.

To configure the rules associated with a Service Group, the IT user would do the following:

From within the Service Group Manager and a selected Service Group, the IT User Navigates to “Rules”.

The IT User could then enable, disable, or configure one or more rules.

At run-time, the Service Group rules manager uses the rules configuration to dynamically determine which web service adheres to the defined set of rules. These rules are managed independently from the service definition and may therefore be altered at run-time with no disruption to the NetScenario. To avoid invalid configurations, the Service Group Manager will also disallow the IT User from configuring the rules in such a manner that eliminate all possible web services in the group.

Business-to-IT Collaboration

While the target users for NetScenario Studio are business analysts and others with detailed understanding of the business domain, the invention acknowledges the complexities associated with creating online solutions by providing a structured collaboration environment between business users and their IT counterparts. This collaboration mechanism allows business users within NetScenario Studio to request new business functions, integration links and other technical resources from programmers and developers that are subsequently created and returned to the requesting user as standards-based Web Services. The invention leverages Web Service standards and specifically WSDL contracts to enable business-level requests for resource enablement, thus providing a flexible yet sophisticated mechanism for bi-directional contract-based negotiation between business analysts and IT personnel.

Design-Time Project Teams

Entire project teams will typically utilize NetScenario Studio. Similar to other enterprise development environments, the NetScenario software supports teams of users working in tandem to create business services. A major difference in the approach of the NetScenario Studio of the present invention and traditional enterprise programming environments is the present invention's inclusion and participation by cross-functional team members, from the business manager to the Web development engineers to IT specialists. Examples of the benefits of the NetScenario Studio's collaborative features for project team members include:

Explicit recruitment of account users into a project team for each scenario

Assignment of roles and responsibilities to project team members

NetScenario task list views for personal and group to-do's, grouped by project team member

Visual markers (annotations) denoting who last worked on a business step and any comment

Dynamically generated views and access to only those design elements to which a given project team member has access

E-mail and visual notification between NetScenario Studio users

The Importance of Roles

A key enabler for the NetScenario Studio's design-time collaborative features is fine access control via authenticated roles. Roles represent sets of capabilities or access privileges assigned to multiple users to create, publish, deploy and manage scenarios. In addition to limiting access privileges to key platform functions, roles provide the enabling infrastructure for project team collaboration across various phases of the NetScenario lifecycle.

Integration with Native Development Environments

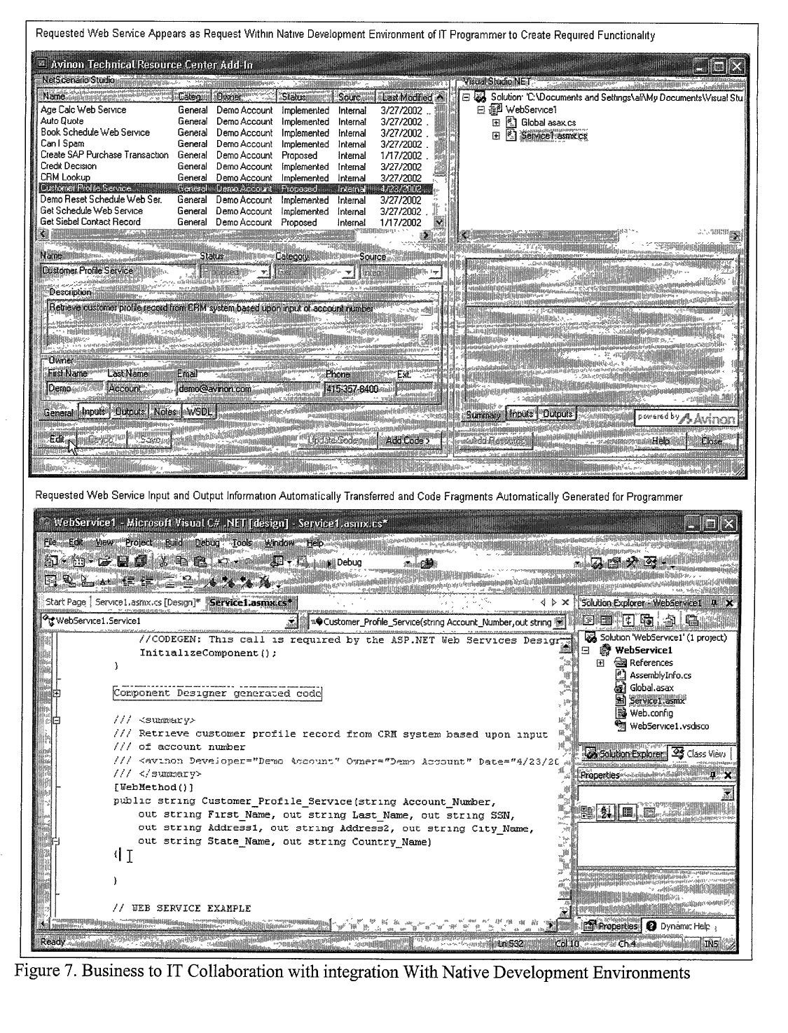

To support collaboration with a technical IT developer, the business analyst can define the inputs and outputs of the step as well as provide a textual description of the functional scope, data manipulation or lookup that needs to be accomplished. With reference to FIG. 7, the Upon completion of a business resource request, the invention automatically forwards the request to the developer's native development environment (for example, Microsoft Visual Studio NET) through a special add-in component that manifests itself as a Technical Resource Center within that native environment. When the IT Developer opens the Technical Resource Center Add-In within their development environment, a “to do” list tailored to their role indicates that a Web service needs to be created and bound to the unfinished step. To facilitate the creation of an appropriate Web service, the step produces a WSDL file describing the previously defined inputs and outputs. The development platform wizard then uses the WSDL file to define interfaces, comments and documentation for the objects that need to be implemented. Because of this method, the developer is able to contribute to the development of an online solution by performing specific well-identified tasks without needing to learn and understand the larger goal. This contrasts with current methods in which the business user must provide a full written specification of the desired online solution to the developer, who then must first learn and understand the entire solution and ultimately implement every aspect of it.

Example Lifecycle of a Collaboratively Developed Web Service

The following example is provided in order to illustrate how the invention enables business-to-IT collaboration. In this case, the assumption is that a new Web service is being created in order to extend the capabilities of a NetScenario.

The Business Analyst

A Business Analyst is defining the business logic for a customer self-help NetScenario. The business analyst recognizes that a custom step is needed to query a legacy system to obtain the text of a previously defined FAQ (frequently asked question; a form of knowledge base). To accomplish this, the business analyst adds a Web service step to the NetScenario and opens the setup dialog. In the setup dialog, the business analyst identifies the product and FAQ names from a previous interface step as the input data for this new step. In the step name field, the business analyst types the name “GetFAQ” and in the step description field, types the following text:

“This Web service takes the name of one of our products and a FAQ name specified by a customer and uses that data to query a legacy system to obtain the requested FAQ. The Web service returns the FAQ text and title.”

Finally, the Business Analyst defines the output of the step as data (two strings) that can be made available downstream in the NetScenario.

At this point, the responsibility of the Business Analyst regarding this Web service is complete, as they have fully described the work that needs to be done in terms of inputs, outputs and any side effects that need to occur. It is now the responsibility of a programmer to implement the functionality described and requested by the Business Analyst.

The Programmer

When the programmer opens the NetScenario, because their role differs from that of the analyst, they see a different view: one that exposes features they need to accomplish their job. The unfinished Web service step includes controls that permit the programmer to select a programming language and associated environment (C#, VB, C++ or Java) and launch a wizard that automatically creates a programming project that exposes the GetFAQ method. The comments for the method include a description of the input and output parameters along with the exact text of the description previously provided by the Business Analyst. The programmer uses their knowledge of the legacy system interfaces to implement the query in the project that was launched.

Internally, the Web services step generated a WSDL file describing the inputs and outputs of the needed method along with the method comments. This is stored in a database repository accessible from both NetScenario Studio and the development environment wizards. The development environment wizards obtain the WSDL information using a local client API which, in turn utilizes web services to provide access to the NetScenario repository. The launched wizard then uses this file to create the object and method definitions and generate a web service to expose them.

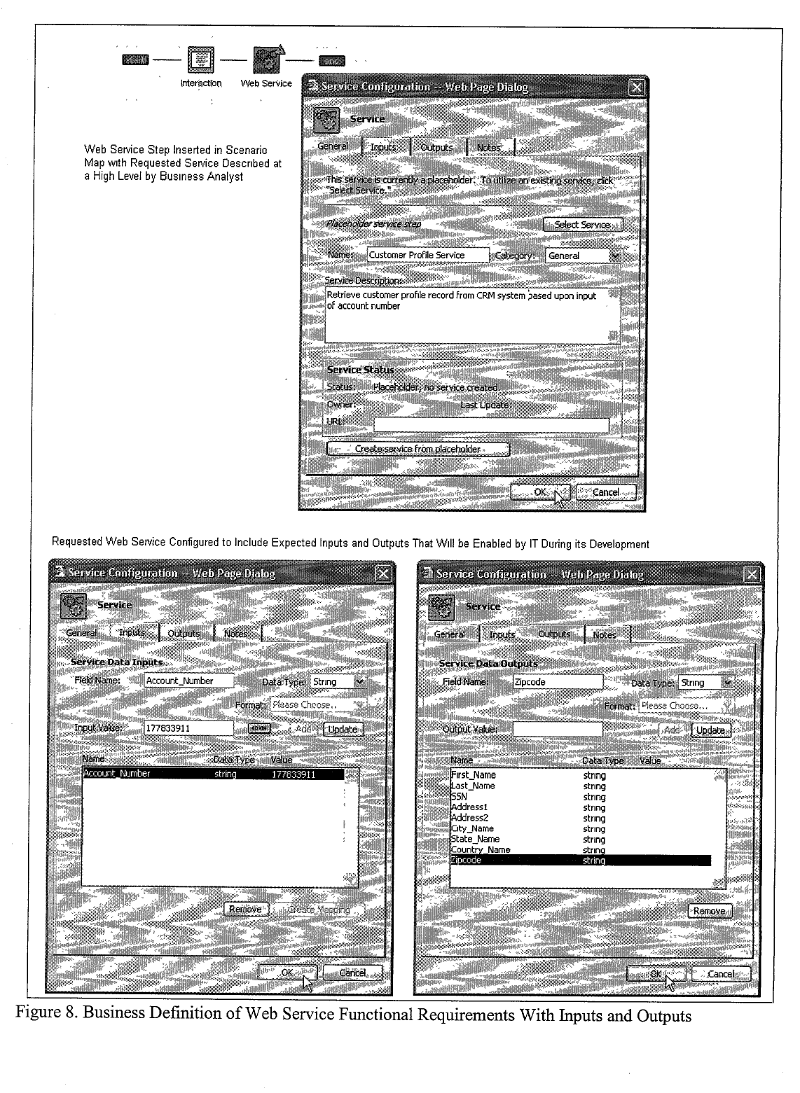

As described above in Section 2b, a business analyst using NetScenario Studio can logically describe their required functionality through placement and configuration of a special Service Step at the appropriate execution point in the Scenario Map. With reference to FIG. 8, the configuration dialog for the Service Step enables business user definition of the function, including a written description and a proposal of the inputs required by the step and outputs it will generate. Through this interface, the invention separates business resource requirements from the underlying technical implementation details, providing a foundation for defining business-relevant service interfaces that are readily understood and employed by business users to create NetScenarios. IT personnel then decide how this request can best be filled (for example, using a third party Web Service, an internally-developed Web Service, a NET assembly, a COM object, EJB object or database query exposed through a Web Service.) If the described behavior, the input, or the output parameters of the fulfilling components differ from those proposed by the business analyst, a negotiation is initiated using email or any other electronic form of notification to resolve the differences.

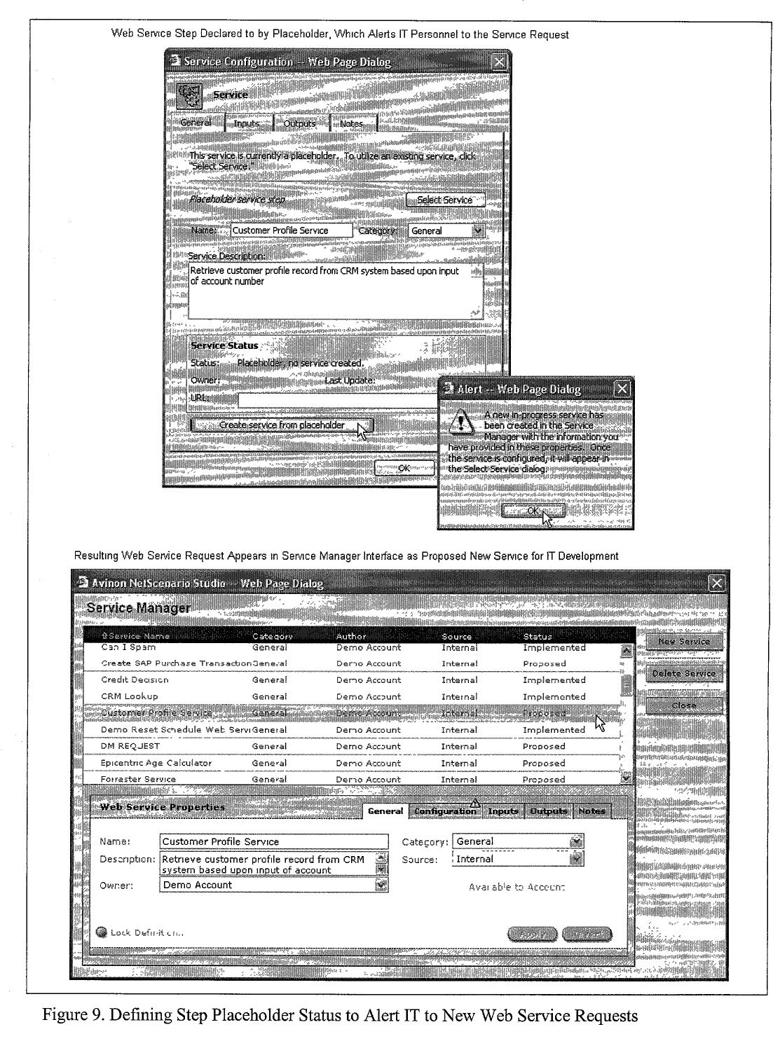

With reference now to FIG. 9, the Service Step configuration interface also enables declaration of a “placeholder” status, that allows IT personnel to perform any required implementation while the business user continues with definition and mapping of the overall service process. Once declared, the NetScenario Studio environment takes any descriptive information and input/output parameters and alerts IT via email notification of the new step implementation requirement. This also frees the business analyst to test the logic of the service process before implementation is complete using the input and output parameters that were defined through the Service Step configuration dialog. In particular, even before the Service Step has been assigned a web service, the business user can run the associated NetScenario (as described above in the on-demand compilation for testing section). When the unimplemented service step is encountered, the system provides the business analyst a user interface for entry of the web service outputs. This enables the entire NetScenario to be tested with any anticipated outputs of the web service before the web service is actually implemented.

To enable structured collaboration between business and IT users, the invention automatically generates WSDL (Web Service Description Language) contracts to describe the functional behavior and input/output requirements specified by business users. This WSDL contract is created upon initiation of the request for a new Service Step, and thereafter is used to contain the proposals, the counter-proposals and the final contract between the business and IT collaboration team. Once the contract is agreed upon, IT completes any needed implementation work and the Service Step associated with the original request is re-integrated into the Scenario Map through final mapping of its actual inputs and outputs.

The Service Manager

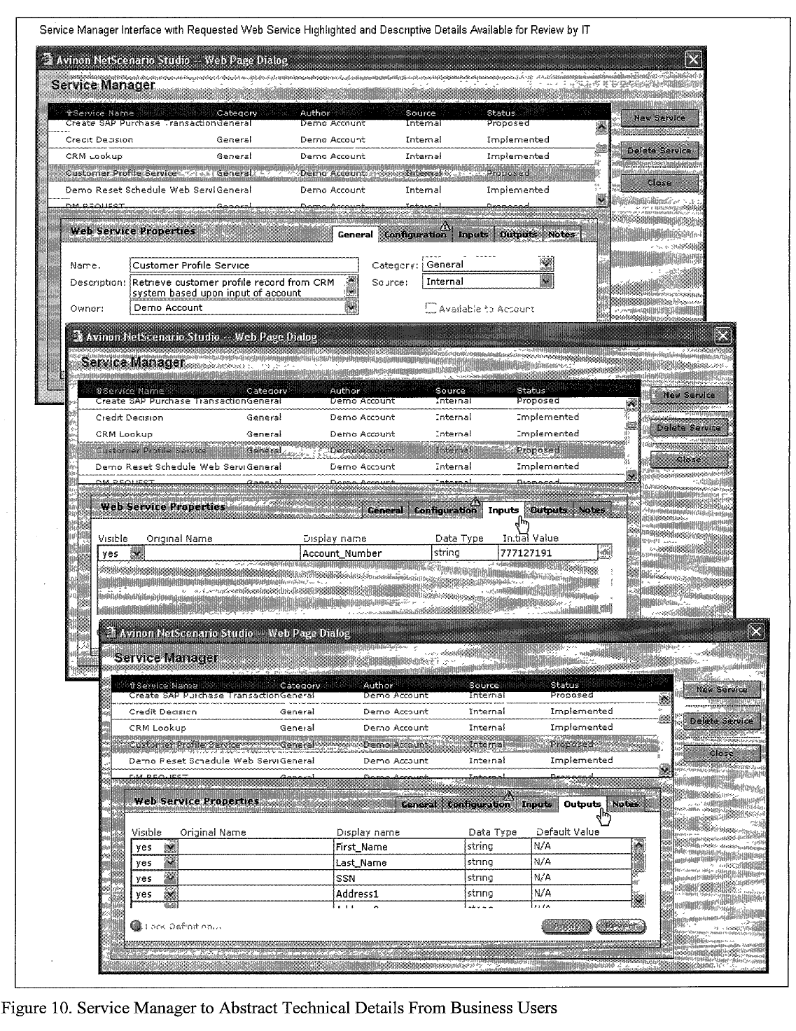

In order to fully enable and provide an optimal collaboration environment, NetScenario Studio provides a centralized Service Manager with both business-level and technical-level interfaces to the Web Service components being requested by business users and developed by IT users. With reference to FIG. 10, the Service Manager manages lists of all requested, implemented and discovered services available to the business analyst. This includes third party Web Services, internally implemented Web Services, COM and EJB objects, as well as stored procedure and other database queries exposed through Web Services. In addition, it contains a list of developed and approved NetScenario subprocesses for use in further abstracting technical complexities such as with transactions and subroutine calls.

The Service Manager makes use of a private UDDI API to enable its business and technical-level interfaces. As new Web Service component requests are submitted, they are automatically posted to the Service Manager where IT users can review and begin the process of resource enablement as described in Section 2c. Components in the Service Manager are classified as “Proposed”, “In Progress”, “Testing” or “Implemented”. A proposed component is defined as one that has not yet been assigned to an IT resource for evaluation. An in-progress component has been assigned, but has not been implemented and/or approved by IT. A test component is implemented by IT based upon the original service request and is available to the business user for testing and verification but can not be published yet. An implemented component has been tested and accepted by the business user and is now published and made available for use within production business services.

These facilities enable Service Virtualization. Service Virtualization changes the traditional view of resources from tangible, physical entities into logical, configurable entities with greater flexibility for both the Business User and IT User.

The abstraction layer provided by the Services Manager offers a number of advantages over traditional methods that provide direct programmatic links to underlying Web Service component functionality. In addition to providing a single, standards-based location for storing and managing functional assets of the business, these advantages include:

A single location for testing Web Service components prior to production use.

A single location for monitoring, logging and metering calls to Web Services.

A single location for defining, managing and monitoring service levels for Web Services.

A single location for discovering Web services and completed NetScenarios published to public or private UDDI registries.

Enables the Business User to continue assembly and testing of the Business Service (NetScenario) in parallel with the IT User's implementation efforts for requested (“Proposed”) services.

The process may be described as follows:

During the assembly phase in the NetScenario lifecycle, the Business User may request a new service from within the Service Step. In doing so, the system uses a placeholder mechanism to represent the service that will ultimately be implemented by the IT User.

The IT User can fulfill this request using the Service Manager or the Add-Ins available for IDEs such as Visual Studio NET and Borland JBuilder.

At run-time the web service request is intercepted by the NetScenario Business Server for any additional processing (e.g. transformations, metering, etc.) and then passed to the actual web service. This interception layer is also the mechanism that enables the Service Groups and service brokering described in a separate sub-claim.

The Service Manager provides a centralized location for unit testing Web Service components before making them available to designers of NetScenarios. A user interface permits the IT developer or programmer to enter test input data and observe the results of the call. This also enables creation of fully parameterized test implementations of Web Services that can be used by business users when testing or staging their completed NetScenario service processes for production use. For example, if a Web Service is designed to debit an account, it cannot actually be used during testing and staging activities. The Service Manager determines whether the component is being called in a test context and calls an alternate test Web Service without the financial side effects.

The Service Groups and web service interception features described above enable the testing and staging modes described here. From within the Service Manager, the IT User may specify the “operation mode” for the service. This operation mode dictates which web services should be called during NetScenario preview or run-time. Since the underlying web service (or other resource type) is loosely coupled from the NetScenario the NetScenario may be run in a number of different configurations without modification to its definition.

The invention permits the business to track and report on the utilization of Web Services after a NetScenario has been deployed. This permits the business to more effectively manage the cost of both internal and externally provided Web services.

This metering capability builds upon the abstraction and interception foundations described in other sub-claims. Since the service virtualization allows the service to represent one or more actual web services, the invention also permits the user to view data in multiple views including: a) singleton (a single web service within the Service Group), b) aggregate (metering data across the Service Group), or c) operation mode (metering data scoped to “assembly”, “test”, “staging”, “production”, etc.).

This metering capability is implicit in the Business Server and requires no additional configuration. The data is driven by other configurations applied to the NetScenario such as operation mode and service group.

Data is viewed at “management-time” and results from the running of NetScenarios in any operation mode. The data collected facilitates the analysis of resource utilization to further enhance the optimization of these resources.

Additionally, this utilization information may be used for billing purposes when working with partners, departments, or customers.

Staging and Deployment

After a NetScenario has been assembled, including required design, development and formatting activities, it is ready for staging and deployment.

Staged Deployment

Staging is a private deployment that makes a NetScenario available to internal audiences for validation and testing purposes. For example, before making a NetScenario available to its target audience, a company may put it through usability, performance and throughput testing in a staged deployment configuration. [See Section 2d, <Sub-claim: Web Service unit testing and alternate test implementations prior to production use>] During staged deployment, the side effects of a NetScenario should be harmless. In other words, they should not cause financial transactions or other side effects that would occur in a non-test runtime environment. Since the target audience is not invoking the NetScenario, test databases and Web Services can be used instead of the actual runtime versions.

Production Deployment

After a NetScenario has been tested in a staged deployment, it is ready for production use by the target audience. Deployment is the process of making an Internet link to the NetScenario available to that target audience. This may involve publishing the link to an existing Web site or portal framework, sending an email message containing the link to a mailing list, rendering the service on a intelligent access device, or adding the link to a public or private UDDI registry. If the NetScenario is to be syndicated, deployment involves making the link available to distributors of the syndicated service process embodied by that NetScenario

Provisioning and Syndication

A NetScenario can change its behavior based on how it is called. When a NetScenario is deployed, a mechanism called “provisioning” permits the appearance or behavior to be modified based on one or more provisioning parameters with which it is invoked.

The Provision System allows the specification of particular parameters at design time. These are combined with certain system-provisioned parameters to produce a provision definition record that is published along with the NetScenario. Each time the NetScenario is deployed, the custom and system-provisioned parameters can be given particular values that are stored as a record associated with the new deployment. Each instance of the NetScenario that runs as part of the new deployment is automatically initialized with values of the parameters defined within the provisioning record. The values in the provisioning record for a particular deployment can be changed at any time and such changes will be seen by the next NetScenario that runs as part of the deployment.

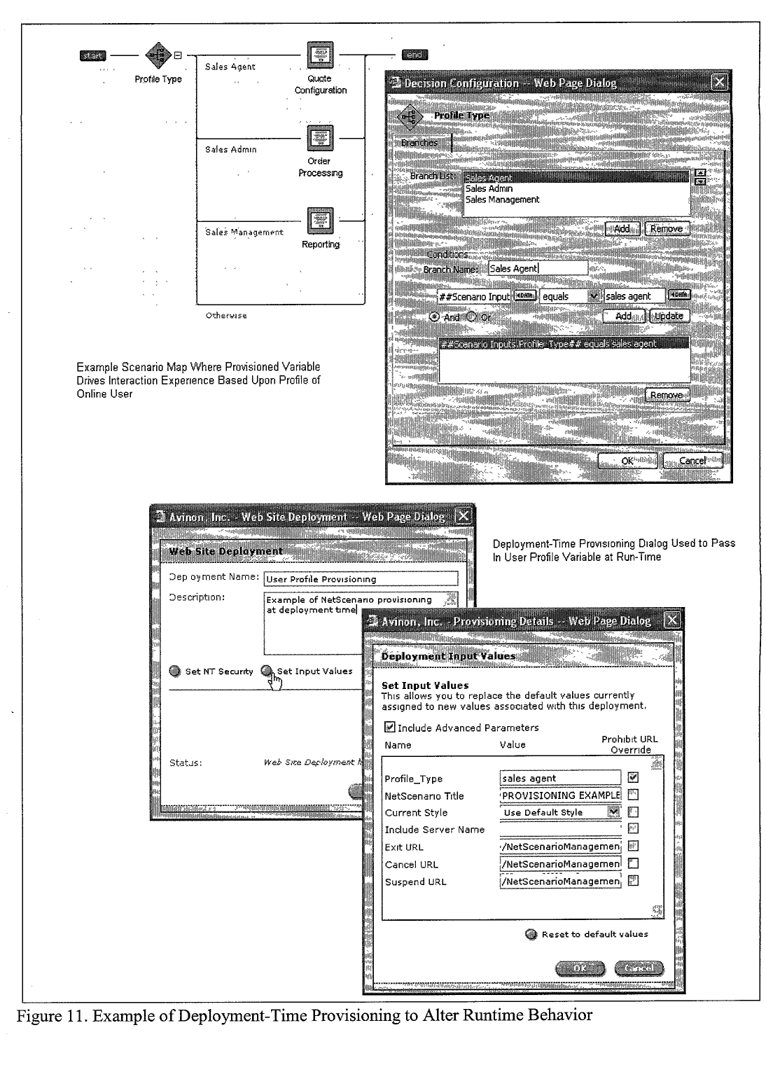

With reference to FIG. 11, provisioning has a variety of purposes, including for example, access control, branding or co-branding, and personalization of runtime behavior. Deployment-based provisioning parameters correspond to variables that control the theme and behavior of the NetScenario.

Since provisioning is deployment based, a NetScenario may be provisioned differently for each channel that is deployed on without changing the NetScenario itself. Built-in system features that take advantage of this include the visual “look and feel” (see theme), the branding and co-branding of the NetScenario presentation that is displayed to the user, and the specific exit destinations used for user redirection upon the completion of the NetScenario.

The same mechanism can be used to allow the NetScenario to be customized to a particular business need. For example a business rule can be easily parameterized to use a value supplied via provisioning allowing its behavior to be custom controlled for each deployment.

The following use cases for provisioning highlight the convenience of adapting a single scenario's appearance or behavior based on its deployment channel:

You have written a self-help NetScenario for use by Silver, Gold And Platinum classes of customers. You create separate promotions to configure three different entry points to the same NetScenario for each customer class. The provisioning associated with each class changes the theme to give them a different look and feel. In addition, the flow of the NetScenario looks at the customer class to determine how quickly the customer is presented with a phone number to call for personalized help.

You have written an order tracking NetScenario that you would like other companies to be able to include inside of their Web applications. By creating provisioning parameters that control the logos, company name and other branding information loaded into the interface pages, you enable the calling applications to co-brand the pages you are providing.

You have written a NetScenario that, among other things, sends emails to individuals. Because you would like to have different instances of the NetScenario associated with different email servers, the NetScenario has a provisioning value controlling the server name. You create separate promotions, one for each server you would like to use.

You are the marketing manager at a national bookstore. You create an “Offer Promotion” NetScenario that is intended to promote the “Best Seller” books to your customer base every month. Within your NetScenario, you decide to provision the ISBN number that uniquely identifies any book. Within your scenario logic, you lookup your national book database based on the ISBN number and include the book/author details in your promotion. You then publish your NetScenario. Your plan is to launch email promotions to your customer base every month where you showcase a new bestseller book. To accomplish this, you create a new promotion (using the same published scenario) each month where you pass in the appropriate ISBN number as a provisioned input parameter.

Provisioning Mechanism Overview:

Design Time

As part of designing the NetScenario, the user may specify set of provisioning variables. To create these variables the user may either create a variable specifically for this purpose, select from the existing variables in the NetScenario or select from the set of step inputs exposed by the various steps in the NetScenario and designate them as being initialized via a provisioning variable. In this case the variable is created implicitly.

The user may provide a default value for the selected provisioning variable. The user may also attribute the provisioning variables indicating special behavior including “read-only”, “overridable”, and “required”. These attributes influence the behavior of the provisioning variable at deployment time and run time.

Creating or selecting a variable creates a special section in the flow map designating the set of provisioning parameters. The provisioning section is interpreted by the Design tool as a step that occurs at the beginning of the flow and provides step outputs that are available to map to the inputs of subsequent steps in the map.

Certain system variables are always present in the provisioning section. System variables, so called because they are initialized by the system, may be given values either at design time (e.g. NetScenario Definition ID), Compile time (e.g. NetScenario Version ID), Deployment Time (e.g. NetScenario Deployment ID), or runtime (e.g. Session ID).

Compile Time

On Compile, the NetScenario compiler transforms the special provisioning record into a runtime provisioning definition. This runtime definition is a data structure consisting or name-value pairs, one for each provisioning parameter. The value part contains either a system default value or the default value provided by the user at design time.

Deployment Time

On Deployment, the runtime provisioning definition is loaded and presented to the user in a graphical form. The subset of the Provisioning record that that is designated as being user settable is presented.

Note: Some system provisioning parameters are not user settable since their values are necessarily generated by the system. User defined provisioning parameters are generally user settable.

The deploying user may provide appropriate values for the various provisioning parameters that are presented. The user must provide values for those provisioning parameters that are attributed as “required”. In addition to providing values, the deploying user may also change certain attributes of the provisioning parameters. This includes the “overridable” attribute which determines whether the value provided can be provided with a different value at run time via a run time parameter passing mechanism.

At the completion of deployment, a deployment record is written along with a new copy of the provisioning record that contains the new values specified by the deploying user along with any default values that the deploying user chose not to replace

Run Time

At run time, the NetScenario is initiated, typically by resolving an URL (Note: other remoting mechanisms may also be used). Invocation identifies the particular deployment of the NetScenario to run by passing a deployment Identifier. The NetScenario runtime uses this identifier to find and load the provisioning record associated with the deployment. If the invocation supplies additional parameter values these are match, by name, to the values in the loaded provisioning record. In this case the values so passed are used to override the value defined in the provisioning record subject to the attributes associated with the particular provisioning parameter in the deployed provisioning record. For example, if the provisioning parameter does not have the “overridable” attribute then the attempt to override the provisioning parameter is not allowed and the value set in the provisioning record will be used.

The NetScenario runtime uses the provisioning parameters to instantiate the NetScenario initializing it with the data from the provisioning record and modified by the invocation parameters. This data becomes a part of the NetScenario instance data.

Since provisioning parameters can be controlled by the identity of the calling user, users with different profiles can have distinct user experiences (both visually and functionally) when running the NetScenario. Provisioning is extended to allow selection of a particular NetScenario based on the user's profile. Specifically, if the user belongs to a particular group then this membership may be used to determine which set of provisioning parameters should be used when presenting the NetScenario instance to the user.

NetScenarios orchestrate discrete Web Services, business rules and processes into interactive business services. This presents a tremendous opportunity to online service providers, e-commerce divisions of large enterprises, or market makers that are currently publishing their core services as discrete Web Services to UDDI. Using NetScenario Studio, service providers can wrap their Web Services as the present invention's Steps and link them together with business logic and rules, and superimpose interfaces and personality to create interactive and modular business services that are registered with UDDI. These NetScenarios are then immediately available for direct use by service consumers or syndicated within other NetScenarios with no coding or integration required.

NetScenarios can be “Syndicated” or made available to third parties as the embodiment of an online business process. Because the same NetScenario can be deployed in multiple settings with its appearance and behavior controlled by provisioning parameters, companies subscribing to the syndicated NetScenario can easily personalize it to match their corporate standards. This dramatically simplifies packaging and sharing of core business processes and not just simple XML business document schemas between partner companies.

NetScenario Services are the system and component application services that implement and control NetScenario behavior at the time it is being run by a user.

Interaction services drive the control and presentation of online interactions with users of NetScenarios.

Integration services dynamically manage the integration and data exchange between NetScenarios and external systems such as Web services and other applications.

Syndication services manage and control NetScenario branding, provisioning and publication.

Profiling services manage the authentication and authorization of NetScenario recipients.

Foundation services provide advanced caching, session and state management, security and data integrity capabilities at runtime.

Runtime Environment Overview

At runtime, the NetScenario is dynamically created based on XML process and interface descriptions. The provisioning support discussed above makes it possible to control the theme, style and behavior of the NetScenario based on the provisioning parameter with which the NetScenario is called.

User Driven Process Navigation

Unlike most commercial software engines that automate business processes, NetScenarios are principally controlled from a Web browser or other intelligent access devices by a human being. Because of this, ordinary process flow can be disrupted by the use of the browser's history list or back button. NetScenarios are executed by a unique user-driven process engine (described below) that addresses this problem.

The NetScenario keeps an internal history of NetScenario pages that the user has moved through. If the user uses the browser back button or effect a restart by using the browser refresh button, the NetScenario Platform automatically finds the correct page and either continues from that page or redisplays that page.

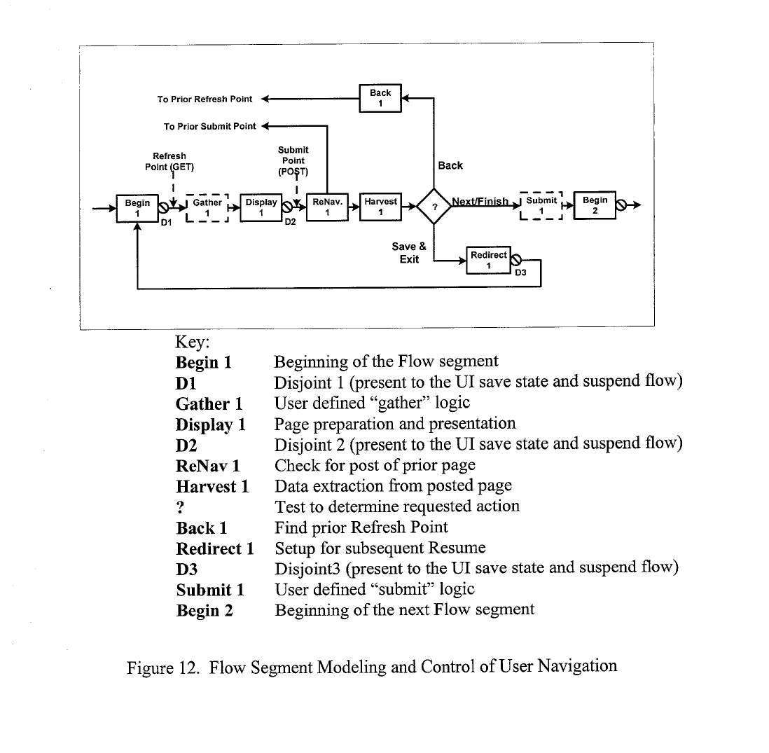

With reference to FIG. 12, a Flow segment is a discrete unit of flow that provides a means to prepare data for presentation, present the data and collect a response and allow various mechanisms to arbitrarily re-enter the unit of flow as directed by the User Interface.

The flow enters the segment at Begin 1. It saves state and synchronizes with the User Interface. This occurs at D1. For a Browser based user interface this requires a re-direct to which the Browser responds with a GET. There is no user input. The flow is typically suspended until the Browser request arrives.

The gather phase, Gather 1, of the flow segment executes. This is user defined logic, the intent of which is to gather data for subsequent use in the flow. Other actions may also occur

At the completion of the user defined gather section of the flow the defined page is prepared and initialized with the data from the flow instance, Display 1. This data may originate from the previous Gather 1 phase and/or from a prior flow segment. The page is presented to the User Interface and the state is saved (D2). The User Interface collects data from the user and submits it back to the flow. The flow is typically suspended while the User Interface is preparing its response. For a Browser based user interface, this requires a PUT response, to the previous GET request resulting from D1. The Browser, at the user's request, responds with a POST which causes the flow to continue. The flow, ReNav 1, checks that the data thus submitted corresponds to the page that belongs to this segment. If the page is not the last one presented then the flow will reset it position back to the appropriate segment at the Submit Point in that segment. This is accomplished using a segment identifier that flows through the User Interface and is submitted back to the flow as part of the data submitted by the user. If the page is the one from the current segment then the flow continues. For a Browser based user interface, a hidden field or a query string parameter may be used to return the segment identifier to the flow.

The flow then harvests the data submitted by the User Interface, Harvest 1.

The submitted data includes an indication of the desired user action. A set of standard actions are provided. These include Next, Finish, Back, Save&Exit and Cancel. Other actions may be defined.

If the Next or Finish actions are requested, the flow executes the submit section, Submit 1. This is user defined logic, the intent of which is to take action on the data submitted. The Flow then proceeds to the next segment, Begin 2.

If the Back action is requested, the flow examines the flow history, Back 1, and identifies the Refresh Point of the segment that was executed immediately prior to the current one. The flow will reset its position back to the Refresh Point of the appropriate segment.

If the Save&Exit action is requested, the flow prepares its state to restart at the beginning of the current segment, Begin 1, and saves its state (D3). It informs the UI that the Save&Exit has occurred and the flow is, typically, suspended. For a Browser based user interface there is a re-direct to an appropriate URL.

If the Cancel action is requested (not shown in the Figure), the flow informs the User Interface that the Cancel has occurs and the flow finishes. For a Browser based user interface there is a re-direct to an appropriate URL.

(Note: Errors that may occur within the flow segment may be handled by re-executing the flow segment starting at either the Refresh Point or the Submit Point depending on the nature of the error. This is not shown in the figure for clarity.)

Navigational Actions Summary

Next

The user submits the current page causing the flow to continue and either complete or generate the next page which is presented to the user. The user is allowed to return to a previous page in the flow by using either the Back button or by selecting a cached page from the Browser History (see Browser History & Refresh).

Finish

The user submits the current page causing the flow to continue and either complete or generate the next page which is presented to the user. The user is not allowed to return to a previous page in the flow by using either the Back button or by selecting a cached page from the Browser History (see Browser History & Refresh). The flow will warn the user and re-direct them back the current page.

Back

The user requests the flow to back up to the previously displayed page. The flow regenerates the previous page and redisplays it.

Save&Exit (Resume)

The user request the flow to save its state for later use. The flow temporarily completes and the user is provided with a special resume token that may be used to resume the flow at a later time. The resume token is generally an URL but may take other forms. By default the flow resumes on the same page from which Save&Exit was requested. Other options such as the following page are also possible.

Browser History & Refresh

The user uses the Browser refresh function to request a displayed page, cached by the Browser, be regenerated and redisplayed. The displayed page may be either the latest page generated by the flow or a previous page cached by the Browser in its history. The flow will re-synch to the page being refreshed allowing the user to continue from the refreshed page.

The Redirection Model

When remote NetScenarios are nested it creates a situation where the combined user experience is dependent on a variable number of disjoint servers operating flawlessly. The larger number of independent servers, the more likely there is to be failure.

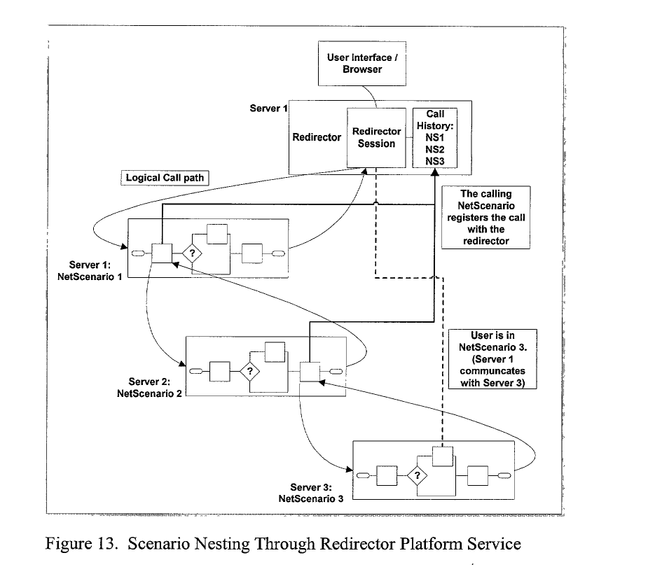

With reference to FIG. 13, this is addressed by calling the root NetScenario through a special platform service component, the NetScenario Redirector. The NetScenario Redirector maintains browser sessions and monitors the NetScenario. The NetScenario Redirector keeps a server-side history of NetScenarios that the user has moved through. If the user uses the browser back button or resubmits requests using the browser refresh button, the NetScenario Redirector is responsible for finding the correct NetScenario and submitting the request to it. When one NetScenario is about to call a nested NetScenario, instead of making the call directly the NetScenario returns the information necessary to make the call. This is intercepted by the Redirector, which records the state of the current NetScenario and makes the call to the underlying NetScenario. The browser will then interact with the underlying NetScenario through the Redirector rather than through the NetScenario that initiated it. When the underlying NetScenario finishes processing, it returns to the Redirector, which then resumes the first NetScenario.

This mechanism handles an arbitrary level of NetScenario nesting while retaining a maximum of one server-to-server call. This method synchronizes the arbitrary navigation page navigation allowed by a browser with nested NetScenarios in a distributed environment.

As shown in FIG. 13, a Browser is being used to present NetScenario 1 which nests NetScenario 2 which nests NetScenario 3.

NetScenario 1 is instantiated via the Redirector which records the instantiation. NetScenario 1 executes. When NetScenario 1 calls NetScenario 2 it does so through the Redirector. The Redirector records the call and instantiates NetScenario 2 on Server 2. NetScenario 2 executes and when it calls NetScenario 3 it does so through the Redirector. The Redirector records the call and instantiates NetScenario 3 on Server 3. When NetScenario 3 completes it returns to the Redirector which resumes NetScenario 2 at the point of the call to NetScenario 3. The return to NetScenario 1 is similar.

In addition to the call history kept by the Redirector, each NetScenario keeps track of its segment execution history via a list of Segment identifiers. This in combination with the NetScenario Instance ID allows user re-navigation via refresh or back to be directed back to the correct server and to the correct segment of the previously executed, calling, NetScenario.

Other responsibilities of the Redirector are to keep alive remote server sessions and close sessions when re-navigation indicates a NetScenario is no longer valid.

The Interception Model

A caller (e.g. a Server, a Browser or some other User Interface) calls the Server requesting a NetScenario to be instantiated. This request is intercepted and various auxiliary systems are invoked. These auxiliary systems may include Authentication and Authorization systems, Metering and Billing systems. The Interceptor collects the context data (e.g. nature of request, user identifiers, and so on) and prepares it for the subsystem passing it through a defined calling interface implemented by a subsystem adapter. The adapter is implemented specifically to call a particular sub-system. The Interceptor calls each registered auxiliary system adapter and accumulates any results. If appropriate, the results are passed to the NetScenario.

This system is also applied to Web Services.

Visual Transactions

Transactions in a visual, user-driven environment have traditionally been a problem for Web application builders. In particular, application builders have had to explicitly expire previous Web pages when transaction issues preclude user-driven navigation to those pages. For example, if a payment amount has already been submitted to a payment service, it would be an error to permit the user to back up and change the amount without a rollback of the transaction. NetScenarios resolve this problem by introducing the notion of a visual transaction. In a visual transaction, data gathering and submission steps are explicitly identified and segregated during the assembly process. At runtime, user attempts to navigate backwards can be determined to be safe by examining whether they cross a submission or commitment boundary. If the navigation is unsafe, the navigation can be disallowed or the user can be re-routed to the beginning of the visual transaction.

The invention's Gather-Submit technology is a NetScenario design pattern that separates the user interaction from the action that is taken as a result. All presentation and collection operations involving the user take place during the gather phase and all actions resulting from that interaction take place during the submit phase. The gather phase collects all the data required to perform the submit phase. Generally, if the submit phase fails then the gather phase must be repeated.

To achieve this, certain restrictions must be enforced as follows:

There can be no action steps during the gather phase

There can be no Interface steps during the submit phase

The gather phase has a defined entry point. It is not permitted to enter the gather phase at any other point.

It is permitted to jump out of the gather phase.

The submit phase has a defined entry point. It is not permitted to jump into the submit phase at any other point.

It is not permitted to jump out of the submit phase except on error or on completion.

Gather sections can be suspended and resumed under user control. They can also be canceled by the user.

Submit sections do not operate under user control and thus may not be directly canceled or suspended by user commands.

In addition to these rules, some other characteristics of the Gather-Submit design pattern are:

Gather-Submit units may be chained to form a series of discrete actions.

Gather-Submit units may be merged to form a single Gather-Submit NetScenario. Alternative Gather sections may be defined for a particular submit and, perhaps less usefully, the reverse.

These are discussed below in the section “Combining Gather-Submit NetScenarios”.

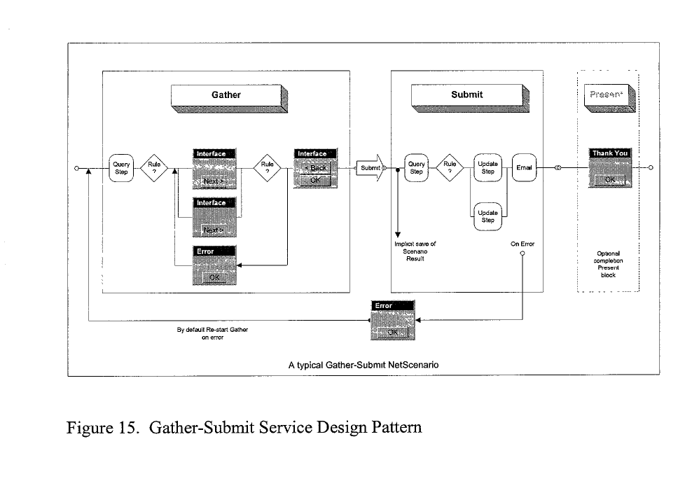

FIG. 15 illustrates a simple NetScenario that conforms to the Gather-Submit design pattern.

At the start of the gather phase a database query is made.

The result of this query is tested with a rule that determines which page is presented to the user.

The appropriate page is presented to the user and the user submits their request back to the NetScenario by pressing the Next button.

The content of the request is tested with a rule.

If the request contains errors, the NetScenario returns to the rule and re-presents the appropriate page.

If the request is valid the NetScenario continues to a confirmation page. On this page the user may back up and re-edit their request or they can submit the request.

The request is submitted to the submit phase.

The submit phase queries a database based on the request submitted.

It then applies a rule and updates a database appropriately.

It then creates an email and queues it.

Finally it updates the NetScenario results. The transaction commits and the submit phase is complete.

The user might be directed to the next phase. In this case the next phase is a Present section implementing a confirmation page.

If an error occurs during the submit phase the transaction aborts and the submit phase exits.

NetScenario Transaction Model

NetScenarios have an implicit transaction model. This leverages the modern distributed transaction approach popularized by COM+ and later by EJB. In this model NetScenario Steps execute in the context of a transaction. Assuming the steps can participate in this kind of transaction, their actions will either commit or abort depending on the error-free completion of all the steps participating in the transaction. That is, they will all succeed or they will all abort.

Certain rules should be observed when using transactions. In particular, transactions should not be held open for long periods such as when a user has control. The NetScenario transaction model conforms to this.

The Gather-Submit design pattern also contributes to the transaction model in that it confines all actions to the submit section of the NetScenario. It also restricts the logic in the submit section to either executing the actions to completion or failing.

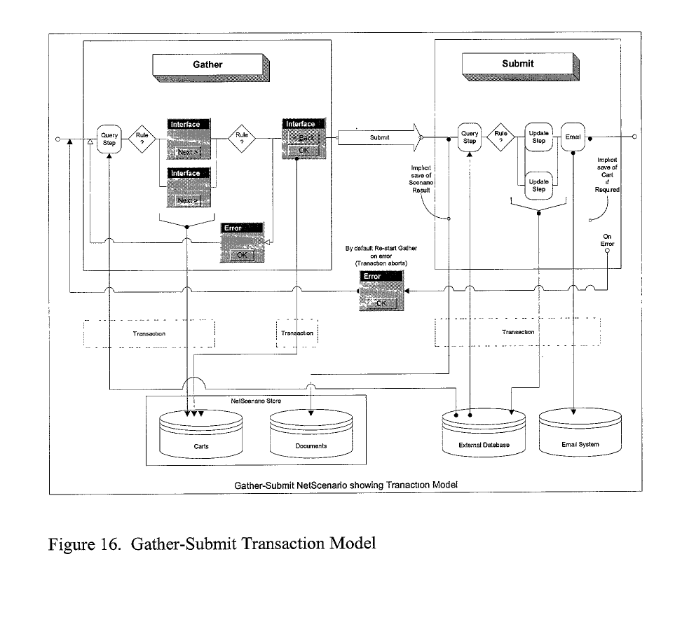

FIG. 16 illustrates the Gather-Submit transaction model for a simple NetScenario.

The Present and Action Design Patterns

There are two related design patterns that apply to NetScenarios: Present and Action. Present is equivalent to a standalone Gather section and Action is equivalent to a standalone Submit section. Both of these patterns may be useful either in their own right or as modules with which to build conventional Gather-Submit NetScenario designs. These patterns are described below

Present

Present is equivalent to a standalone Gather section. It is differentiated from Gather since its primary purpose is to present data rather that gather data. While a Present NetScenario can gather data it does not have a corresponding Submit section and so it cannot, on its own, do this usefully. It is also possible to construct a Present NetScenario that doe not have a UI, the purpose of which is to programmatically present some data.

There can be no action steps in a Present NetScenario.

Present has a defined entry point. It is not permitted to enter the present phase at any other point. It is permitted to jump out of the present phase.

Present sections can be suspended and resumed under user control. They can also be canceled by the user.

In addition to these rules, some other characteristics of Present NetScenarios are:

Present NetScenarios may be chained to form a series of presentations.

Present NetScenarios may be merged to form a single Present NetScenario.

A Present NetScenario may be merged into the Gather section of a Gather-Submit NetScenario.

Action

Action is equivalent to a standalone Submit section. It is differentiated from Submit in that it can only be used programmatically. Its primary use is as a building block for other NetScenarios or for allowing NetScenarios to be initiated from other programmatic systems.

There can be no Interface steps during an Action NetScenario

An Action NetScenarios has a defined entry point. It is not permitted to jump into an Action NetScenario at any other point.

It is not permitted to jump out of an Action NetScenario except on error or on completion.

Action NetScenarios do not operate under user control and may not be directly canceled or suspended.

In addition to these rules, some other characteristics of Action NetScenarios are:

Action NetScenarios may be chained to form a series of discrete actions.

Action NetScenarios may be merged to form a single Action NetScenario.

An Action NetScenario may be merged into the Submit section of a Gather-Submit NetScenario.

Combining Gather-Submit NetScenarios

Combining NetScenarios is a powerful idea since it allows re-use of a previously implemented and tested NetScenario. This contributes greatly to the rapid development and deployment of NetScenarios.

There are two obvious ways to attempt to combine NetScenarios; Linking and Nesting.

Linking. This allows one NetScenario to be linked together so that the NetScenarios may be executed in some sequence. There is not necessarily an expectation that the NetScenario will return to the original NetScenario.

Nesting. This allows one NetScenario to be called from another NetScenario as a sub-routine. The expectation is that the called NetScenario will return to the caller with some result.

By providing a model that streamlines and formalizes the way NetScenarios can be combined the usage model can be simplified and much of the work to combine the NetScenarios correctly can be automated. Gather-Submit NetScenarios can be combined using “chaining” and “merging”.

Chaining. In this arrangement each Gather-Submit NetScenarios are combined in sequence at design time. Each NetScenarios works independently. If one of the series of Gather-Submit units fails it does not affect the previous Gather-Submit units that successfully completed. The failed NetScenario may be repeated until it succeeds.

Merging. In this arrangement simple Gather-Submit NetScenarios are merged so that the Gather sections form a single aggregate gather section and the Submit sections form a single aggregate submit section. The user is given the single event experience while the submit sections can potentially occur in a single transaction.

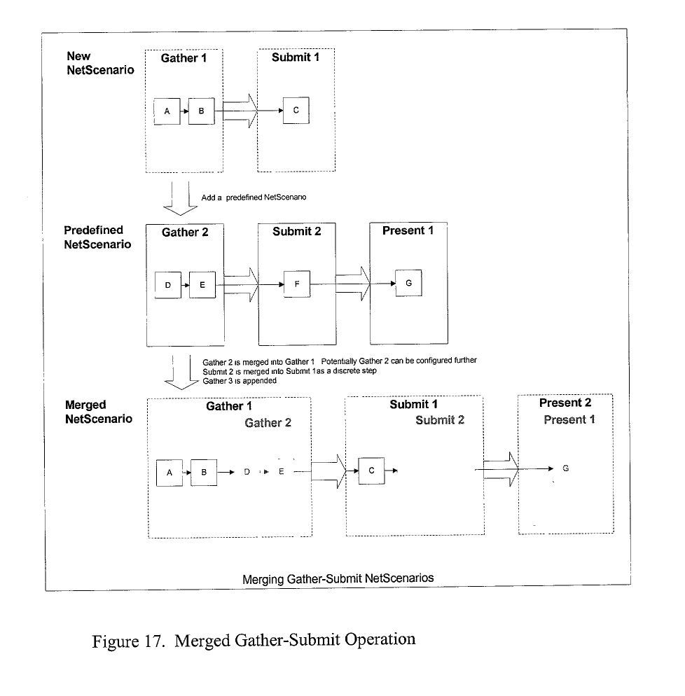

Of these, the merged Gather-Submit creates the most usual and desired user experience, particularly if it can be arranged for the submit sections to combine into a single transaction. FIG. 17 provides an example of a merged Gather-Submit operation.

Nesting and Linking Support

The runtime engine supports combining NetScenarios to create more robust solutions by calling a second one from within the first as a subroutine (nesting) or by transferring control to a second NetScenario after the first has completed (linking).

Networked Business Services

Individual NetScenarios typically model a single interaction with a customer. Because business processes frequently include multiple interactions with multiple parties, the invention provides a Networked Business Services (NBS) model that was developed to combine and coordinate the execution of distinct NetScenarios into unified solutions. The NetScenarios contained in the NBS represent visual interactions with end users in the process. Unlike a discrete NetScenario, NBS is multi-party (roles) and has multiple entry points.

Building upon the Gather-Submit NetScenario design pattern, the present invention's NBS model logically aggregates multiple single-input, single-output NetScenarios into a visually cohesive service network with a shared data model. NetScenarios aggregated within the present invention's NBS model have distinct visual representation during both design-time and runtime:

Design-time: The NetScenario Studio provides a visual wrapper around the individual NetScenarios aggregated into a network, representing connectivity linkages and dependencies amongst them.

Runtime: To NetScenario recipients, the relationship between the individual NetScenarios that have been aggregated into a logical whole appear seamless and offer unified experiences as with most other enterprise application interfaces.

NBS coordinates data and runtime behavior of related NetScenarios and provide a common environment for administering them as a group. These features are further described below:

Data Coordination

Data must be able to be shared between NetScenarios contained in an NBS. To support this, the present invention's NBS permits the definition of XML document schemas that can be shared between NetScenarios. Even if an intervening external process engine does some work between NetScenario invocations, an XML document that was created by one NetScenario can be transferred to and understood by another.

Process Flow Capabilities

The NBS provides standard process control facilities such as decisions, routing and splitting and combining documents between NetScenarios. These capabilities permit an exchange to select work from output consoles (i.e., a service list control) and route them to other input consoles (i.e., an service inbox control) for further processing.

Connections

In addition to listing the NetScenarios, NBS provides a description of the relationship between these NetScenarios known as Connections. The relationships that NetScenarios may have are:

Direct

Exit Links—On exit a NetScenario may re-direct to another NetScenario.

Popup Links—During NetScenario execution the user may initiate additional NetScenarios in separate windows either modeless (independent completion) or modally (completion required before continuation).

Nested—A NetScenario can be called as an integral part of another NetScenario.

Indirect

Disjoint Links—During execution of a NetScenario, a NetScenario Link may be communicated to another actor (generally a user) via Email, NetScenario Inbox or some other communication mechanism.

Non-NetScenario “Glue”—The NBS model permits connection to certain non-NetScenario Web Pages intended to bind NetScenarios (e.g., Portal page).

Dispatcher—Some NetScenario Business Service Models may require additional rules and facilities to link the NetScenarios together. Generally these will involve criteria matching, scheduling and workflows.

The Relationships between NetScenarios are visually created by editing the Connection. This Connection documents and characterizes how the invoking NetScenarios and the invoked NetScenario (or link) related.

Each NetScenario contributes a Connections list to the NBS. Connections are resources like entities that abstract invocations of other NetScenarios. These NetScenarios are generally defined within the current NBS. Connections define the relationship between the various NetScenarios within the NBS and allow the NBS to manage these relationships.

Connections abstract the details of the connection from the initiating NetScenario. Included in these details are the signature of the resource connected to signature and the mechanism through which the resource is invoked. NetScenario Subprocesses also produce Connections lists but never appear in them.

Signatures

Callable entities, specifically NetScenarios, Subprocesses, and Resources carry defined signatures describing how they are invoked. In general this consists of a set of inputs, a set of outputs and their data types. If necessary, NetScenarios add a description of their “Business Document”. Resources may describe a group of signatures since these signatures are changed together. Signatures are owned by the defining entity, and. are used to enforce compatibility. That is, it may be possible to lock an entities Signature from further changes restricting the way the entity can be further changed.

Inputs and Outputs are described by name, order and datatype. This part of a Signature uses a WSDL like syntax. In addition to inputs and outputs, the side effects of a NetScenario are also part of its Signature. This includes a description of the data that appears in its document and in its classification of that document. These descriptions are also WSDL like including name, order and data type. The typing system used in both cases is XML SCHEMA 2001.

Dependencies

Dependencies identify the Resources and Subprocesses that are used by a NetScenario or Subprocess. Dependencies identify all the external resources referenced by the Resource. This includes Connections. The purpose of the Dependency list is to allow the NBS to identify the dependencies of each member of the NBS and manage changes to them from outside the consuming NetScenario (or Subprocess)

Change Management

The Change Management features are centered around Dependencies and Signatures. The same basic mechanism is used for NetScenarios, Subprocesses and Resources. For simplicity the following description uses NetScenario as an example though for most cases Subprocess can be used interchangeably. Resources are discussed separately.

Each NetScenario within the NBS contributes a Signature to the NBS that defined how it may be consumed by other NetScenarios within the NBS. When a NetScenario (or Subprocess) consumes another NetScenario (or Subprocess) it creates a Dependency record in its dependency list.

When a NetScenario changes its Signature and exposes that change, generally on save, a process is run that checks the dependency list of the other NetScenarios in the NBS and those that advertise a dependency on the changed NetScenario are marked as needing attention. This change mark is used to indicate to the user that the dependent NetScenarios require their attention and they must open the NetScenario and make appropriate adjustments before the NetScenario can be used further.

Compatibility

NBS is concerned with managing compatibility between its owned and referenced NetScenarios. There are various standards of compatibility:

Absolute: The compiled NetScenario is identical to it predecessor.

Constant Signature: The NetScenario maintains the same Signature but its internal logic can vary.

Derived Signature: The NetScenario Signature is a superset of its predecessor. That is it has all the same fields in both the Calling and Data Signatures but it adds new fields to either the Calling or Data Signature or both.

Calling Signature: The NetScenario Calling Signature is constant or derived but the Data Signature varies. This is a relaxed standard that allows the NetScenario to operate in place of its predecessor but does not produce a Business document that can be directly compared to its predecessor.

Incompatible: The Signature does not match and is not derived.

Supporting Technical Details

NetScenario Logical Model

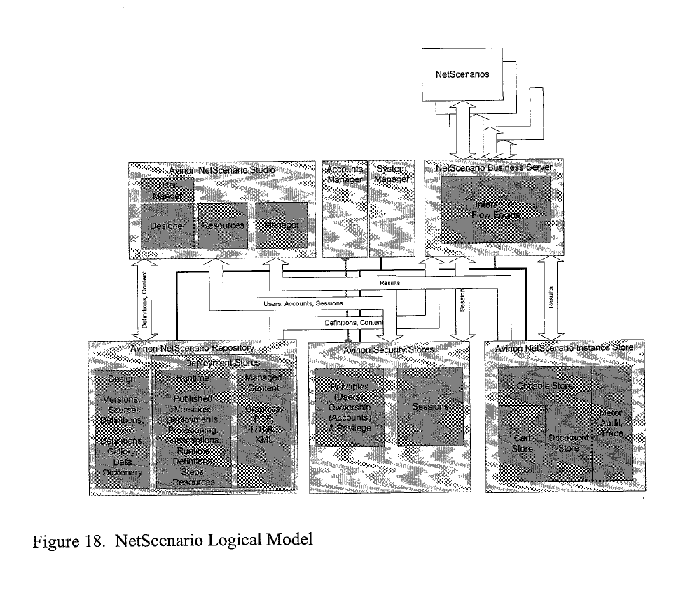

FIG. 18 provides an overview of the NetScenario Logical Model and identifies its key components.

NetScenario Studio

Business Service Assembly and Management environment:

Designer: Concerned with the construction of NetScenarios.

Manager: Concerned with the management of executable NetScenarios.

Administrator: Concerned with management of Account resources.

Reporter: Concerned with making reports and data available to Business and System Administrators.

NetScenario Business Server

Business Service execution engine:

NetScenario Interaction Flow Engine: The engine that actually execute a NetScenario.

NetScenario Repository

The place where NetScenario definitions and supporting data are stored:

Design: Where the design time NetScenario definitions are stored.

Runtime: Where the “compiled” NetScenario definitions are stored.

Managed Content: Where the managed content (graphics, components, etc.) supporting NetScenarios are stored.

Resource: Where the Resource (both Business Resources and Technical Resources) registrations and configurations are stored.

System Store

The store for underlying services required by the NetScenario Platform:

Authentication & Authorization. The store that supports the platform account model:

Principles: The concept of a login

Account: The concept of ownership

Sessions: A store to manage sessions; the runtime context in which NetScenarios and the NetScenario Studio run.

NetScenario Results Data

The place where NetScenario state and result data is stored:

Console Store: A classification of NetScenarios that have run.

Cart Store: The place where the state of an incomplete NetScenario is stored.

Document Store: The place where the result of a complete NetScenario is stored.

Meter Store: Meter records for NetScenarios and business steps (including Web services). When a NetScenario is run it produces a meter record that records various statistics about the NetScenario.

Trace Store: Trace records for NetScenarios. When a NetScenario is run it optionally emits a trace record for each step in the scenario.

Audit Store: Audit records for NetScenarios. NetScenarios can define explicit audit records that are a part of the business logic.

NetScenario Physical Model

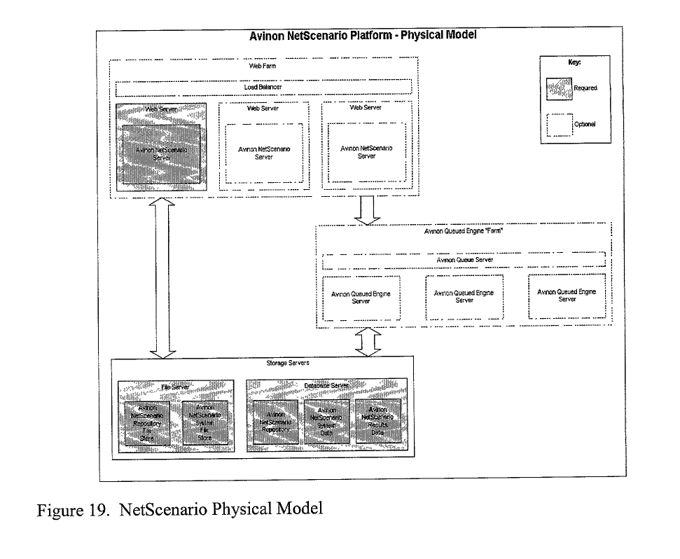

FIG. 19 provides an overview of the NetScenario Physical Model and identifies its key components.

Web Farm

A set of equivalent Web servers organized to balance request load whereby any request can potential go to any server.

Load Balancer

An entity that balances the request load across the Web servers.

Web Server

A server that accepts and responds to t he http messages.

NetScenario Server

A server that executes the NetScenario Business Server software and interaction flow engine Web that creates, manages and runs NetScenarios.

Storage Servers

The set of server s required to store NetScenario data an d state information.

File Server

A server the can store data as files.

NetScenario Repository File Store:

NetScenario Repository data that is stored in the file system.

NetScenario System File Store:

NetScenario System data that is stored in the file system.

Database Server

A server that can manage data in a structured way.

NetScenario Repository:

A place where NetScenario construction data is stored.

NetScenario System Data:

A place where data required to manage the NetScenario Platform is stored.

NetScenario Results Data:

A place where NetScenario results are stored.

Queued Engine “Farm”

[Optional] A system of servers that accept work queued from NetScenanos.

Queue Server:

The server that distributes the queued work to the queue engine servers.

Queued Engine Server:

The server(s) that execute the work queued from NetScenarios.

NetScenario Operational Model

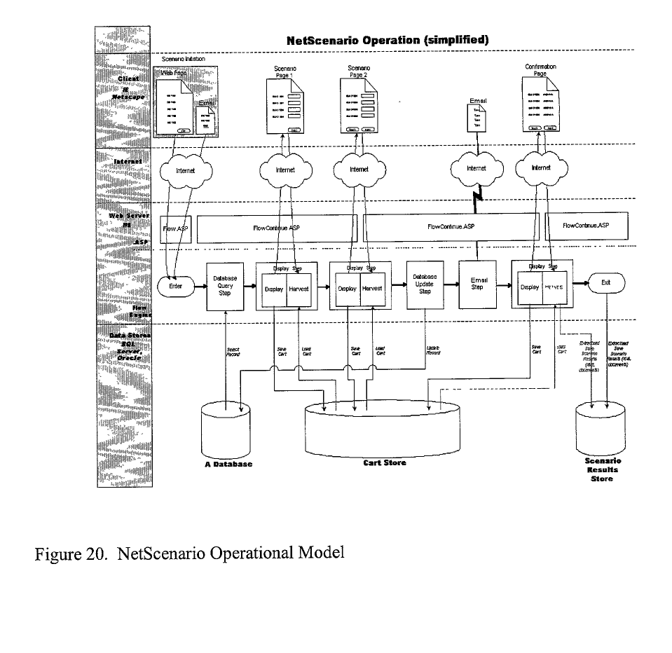

FIG. 20 provides an overview of the NetScenario Operational Model.

NetScenario Execution Summary

Once a NetScenario has been designed it can be published and deployed for use through the online channel of choice. The NetScenario is uniquely identified by its NetScenario ID. A published NetScenario can be deployed multiple times, with each deployment tracked separately. The NetScenario is deployed as a parameterized URL referencing the site where the NetScenario will run. This URL may be placed in an email, on a Web page, deployed through an enterprise portal, or delivered to an intelligent access device such as a PDA. Deployments may also be registered with a UDDI-compliant registry for centralized discovery of NetScenarios.

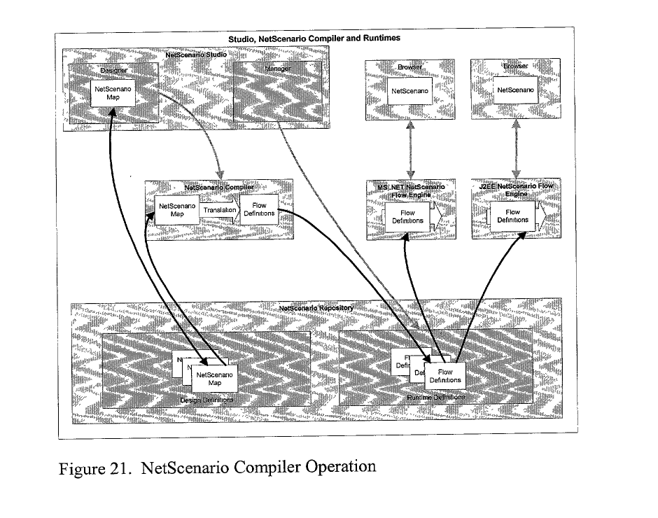

With reference to FIG. 21, the NetScenario is initiated when a user (directly or indirectly) invokes the deployment URL. The deployment URL points to an instance of the NetScenario Business Server which reads the URL parameters, validates the existing session (or creates one), instructs the engine to create a Service Cart—an XML container that holds the real time interaction data—and starts the NetScenario.

A NetScenario executes in the context of a session. The session is used to provide a security context mechanism to govern and manage a running NetScenario. It is used as the access point to the user profile data to facilitate the enforcement of NetScenario access security as well as NetScenario personalization. The Session object is maintained separate from the Service Cart, which allows users to run multiple NetScenarios within a session. Each NetScenario uses its own Service Cart.

The session is implemented as a server side object that can persist. On creation the session gets a globally unique ID. The session is persisted and the session ID is passed back to the client. To access the session the client passes the session ID back to the server with each request. The session ID is maintained as client-side state for the duration of the NetScenario. This is achieved using an in-memory browser cookie.

NetScenarios always run in the context of a session. This facilitates challenge-response authentication such as NT integrated security. A session is created either as part of an explicit user login or implicitly as part of the NetScenario initiation. Implicit session creation is only allowed for NetScenarios that allow anonymous access. If the NetScenario requires login then the caller passes a valid session ID as part of the NetScenario. The present invention allows delegated session creation whereby a calling server takes responsibility for user login and creates a session on behalf of the user. Since the session ID is globally unique it never repeats across sessions. This means that the session is only valid until it times out.

The session provides a mechanism that is sufficiently secure for many NetScenarios. However it does not protect the data exchanged over the wire. To protect against network snooping, NetScenarios may be run over SSL connections using HTTPS protocol. This technique encrypts the data exchanged between the client and the server. The management tools within NetScenario Studio present a deployment option to run the assembled NetScenario over SSL.

It is important to note that the NetScenario Business Server is designed to work in a scalable Web farm. It supports multiple load-balanced Web servers and does not require that a user session be tied to a particular server. In a Web farm configuration it is likely that a user will be directed to a different Web server each time they submit a page. Consequently, the Service Cart data is persisted to the database on completion of each display page generation and re-loaded on each NetScenario page submission from the user. In addition to the normal data caching that occurs as part of the database operation, the NetScenario Business Server leverages its own Service Cart caching mechanism. Alternatively, the server supports “Sticky Sessions,” whereby the user is routed to the same server on each subsequent page submits.

There are three types of NetScenario Maps:

Networked Business Services (NBS) Maps

Scenario Map

Subprocess Map

NBS Maps describe the relationships between the NetScenarios that make up the Networked Business Service. They also keep track of the resources that are used by the particular NBS.

NetScenario Maps describe a sequence of steps that make up a particular aspect of the Business Service. Generally NetScenario Maps implement an interaction with a user. However, they may also implement non-interactive flows such as a system-to-system fulfillment process.

At design time steps are described by their step definition. This defines the inputs that the runtime step expects and the outputs that the runtime step produces. A UI for each step is provided to allow the inputs to be configured. This presents the step definition in an appropriate way and writes the collected instructions for setting the inputs to the appropriate step record in the Scenario Map. This process is generally referred to a step configuration. Inputs generally get their values as literals or from the output of another step.

Subprocess Maps are maps analogous to subroutines that can be represented as a single NetScenario Business Step. They allow NetScenarios to be defined in discrete logical pieces and provide a mechanism to scope data within a NetScenario flow.

The NetScenario Compiler converts the set of Scenario Maps and referenced Subprocess Maps into a corresponding set of runtime definitions. The various Runtime definitions include:

Networked Business Service Definition Set

Resource Inventory Definition

Flow Definition Set

Flow Interface Definition

Flow Extraction Definition

Provisioning Definition

Flow Definition

Page Set Definition

Console Definition

Document Interface Definition

Document Extraction Definition

Document Presentation Definition

The Networked Business Service Definition Set describes the networked service and references all the runtime definitions that make up this networked service. Its essential purpose is to provide a mechanism to manage the set of runtime definitions. A Networked Business Service consists of a group of related NetScenarios and definitions of their relationship with each other.

The Resource Inventory Definition references all the resources that are used by the Networked Business Service definition. These resources must exist for the Networked Business Service to run. Resources may be shared across other Networked Business Services. Examples of resources are Web Services, database queries and NetScenarios that are used by, but are external to the Networked Business Service.

The Flow Definition Set describes a NetScenario service process flow and references all the runtime definitions that make up this NetScenario flow. Its essential purpose is to provide a mechanism to manage the set of runtime definitions. A Networked Business Service Definition Set owns one or more Flow Definition Sets.

The Flow Interface Definition describes the standard and user defined Input and Output arguments of the NetScenario described as a WSDL contract.

NetScenario flow. In some cases it may be identical to the Document Extraction Definition.

The Provisioning Definition provides a description and default values for all the arguments for the NetScenario flow. Both system-defined and user-defined are included. This definition is used to create the Provisioning record for a NetScenario deployment. Since the provisioning definition defines an interface to the NetScenario it is one of the factors that can be evaluated to determine compatibility. The provisioning record is a superset of the Flow Interface Definition. It includes arguments for system level bindings that can only be provided by the Provisioning record.

The Flow Definition provides the execution instructions for the NetScenario flow.

The Page Set Definition groups a set of Page definitions and a Preview definition for this NetScenario flow. A NetScenario flow may have more than one of Page Set Definition to support different client devices.

The Console Definition describes the console classification record that is defined for this NetScenario flow. The console provides a way to find persisted NetScenario instances. It presents a table where each row in the table describes and references a particular instance of the NetScenario. The Console Definition defines the table's columns. A NetScenario does not have to have a Console but without one it cannot support various features that rely on persistence.

The Document Interface Definition describes the set of data that this NetScenario flow creates as its “final” form. It is the set of data that can be seen externally from the NetScenario. This is defined if the Console is defined. The Document Interface Definition is defined in terms of a XSD schema.

The Document Extraction Definition provides the instructions for extracting the set of data described by the Document Interface definition. This is defined if the Console is defined.

The Document Presentation Definition provides a presentation of the data described by the Document Interface Definition. This is defined if the Console is defined.

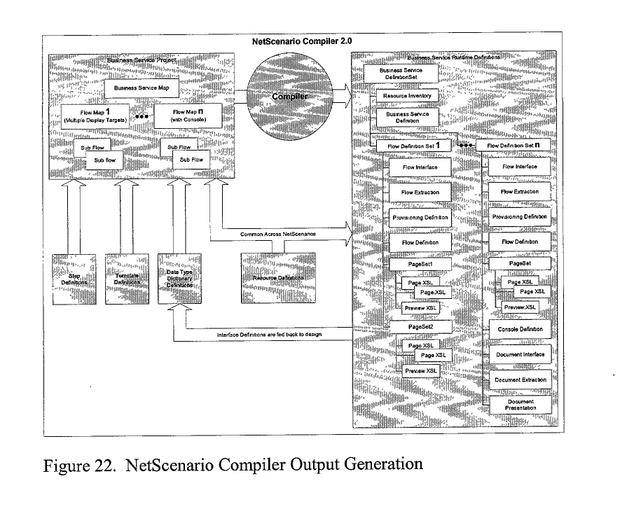

The relationships between these are shown in FIG. 22. The Business Service Project has one or more Flow Maps (Scenario Maps). Two are shown here. Flow Map 1 has multiple display targets (e.g., Browser and WAP). Flow Map n has a Console. These are compiled to Flow Definition Set 1 and Flow Definition Set n.

1. A method for creating on-line business applications from Web-service components:
providing an assembly module that is configured to model business applications;
including the Web-service components as elements in the assembly module;
using the Web-service components to execute business functions and create a multi-service application.

2. A method for creating on-line business applications from Web-service components:
providing an assembly module that is configured to model business applications;
including the Web-service components as elements in the assembly module;
discovering selected Web-service compoents from standards based registries;
using the Web-service components to execute business functions and create a multi-service application.

3. A method for creating on-line business applications from Web-service components:
providing an assembly module that is configured to model business applications;
including the Web-service components as elements in the assembly module; and
using Web-service standards to enable collaborative development of multi-service applications.

4. A method for creating on-line business applications from Web-service components:
providing an assembly module that is configured to model business applications;
including the Web-service components as elements in the assembly module;
creating a technical abstraction layer from the Web-service components and enable a business level use of the Web-service components.

5. A method for creating on-line business applications from Web-service components:
providing an assembly module that is configured to model business applications;
including the Web-service components as elements in the assembly module;
using the Web-service components to execute business functions and create a multi-service application; and
dynamically provisioning the multi-service application to personalize run time behavior and provide value chain syndication.

6. A method for creating on-line business applications from Web-service components:
providing an assembly module that is configured to model business applications;
including the Web-service components as elements in the assembly module;
using the Web-service components to execute business functions and create multi-service applications; and
combining at least two multi-service applications to create a networked multi-service application.
